(19) United States
(12) Patent Application Publication
(10) Pub. No.: US 2026/0219617 A1
(43) Pub. Date: Jul. 30, 2026

(54) IMAGE FORMING APPARATUS AND IMAGE FORMING METHOD

(71) Applicant: FUJIFILM Business Innovation Corp., Tokyo (JP)

(72) Inventors: Kenji KAJIWARA, Kanagawa (JP); Tomotake INAGAKI, Kanagawa (JP); Hitoshi KOMURO, Kanagawa (JP); Takashi OHASHI, Kanagawa (JP); Eiji KAWAKAMI, Kanagawa (JP)

(73) Assignee: FUJIFILM Business Innovation Corp., Tokyo (JP)

(21) Appl. No.: 19/428,372

(22) Filed: Dec. 22, 2025

(30) Foreign Application Priority Data
Jan. 24, 2025 (JP) 2025-010976

(51) Int. Cl. G03G 15/20; G03G 9/09

(52) U.S. Cl. CPC G03G 15/2057; G03G 15/206; G03G 15/2064; G03G 9/0902; G03G 2215/2051

(57) ABSTRACT

An image forming apparatus includes: an image holder; a charging unit that charges a surface of the image holder; an electrostatic image forming unit that forms an electrostatic image on the charged surface of the image holder; a developing unit that accommodates an electrostatic image developer containing a toner that contains toner particles containing a metal pigment having an average equivalent circle diameter of 5 μm or more and 15 μm or less, in which an average value of ratios b/a between a major axis diameter a and a minor axis diameter b in a cross section of the toner particles is 0.5 or more and 0.8 or less, and an average value of areas of the metal pigment occupying a projected image of the toner particles in a case of being viewed in a thickness direction is 0.5 or more and 0.7 or less, the developing unit developing the electrostatic image formed on the surface of the image holder into a toner image with the electrostatic image developer; a transfer unit that transfers the toner image onto a recording medium; and a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at any 50 points by an ultramicrohardness test specified in JIS Z2255 (2003), is 0 or more and 15 or less, the fixing device fixing the toner image onto the recording medium by bringing the surface layer of the fixing member into contact with the toner image on the recording medium and then heating and pressurizing the recording medium.

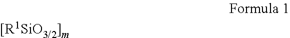

(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group, a plurality of R¹'s may be the same or different from each other,
R² represents a hydrogen atom, a methyl group, or an ethyl group, in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group, the alkyl group, the alkenyl group, the alkynyl group, the aralkyl group, and the aryl group may have a substituent, and
m represents a positive integer)

### CROSS-REFERENCE TO RELATED APPLICATIONS

This application is based on and claims priority under 35 USC 119 from Japanese Patent Application No. 2025-010976 filed Jan. 24, 2025.

### BACKGROUND

### (i) Technical Field

The present disclosure relates to an image forming apparatus and an image forming method.

### (ii) Related Art

In an electrophotographic image forming apparatus, an image is formed by bringing a fixing member into contact with a toner image transferred onto a recording medium and heating and pressurizing the toner image to fix the toner image on the recording medium.

For example, JP1986-158362A discloses a heating fixing roll including at least a surface layer formed of a silicone rubber that is obtained by curing a polyorganosiloxane composition consisting basically of (A) a polyorganosiloxane, (B) a curing agent, and (C) a polymethylsilsesquioxane.

### SUMMARY

Aspects of non-limiting embodiments of the present disclosure relate to an image forming apparatus and an image forming method, that can obtain an image having high luster in a case of forming an image using a toner containing lustrous toner particles, as compared with an image forming apparatus including a fixing member having a surface layer that is a cured product of a composition in which a contained ratio (T type/D type) is less than 1/9 or more than 9/1 or a surface layer in which a difference ΔH between the maximum value and the minimum value of an ultramicrohardness is more than 15.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspects.

According to an aspect of the present disclosure, there is provided an image forming apparatus including:
an image holder;
a charging unit that charges a surface of the image holder;
an electrostatic image forming unit that forms an electrostatic image on the charged surface of the image holder;
a developing unit that accommodates an electrostatic image developer containing a toner that contains toner particles containing a metal pigment having an average equivalent circle diameter of 5 μm or more and 15 μm or less, in which an average value of ratios b/a between a major axis diameter a and a minor axis diameter b in a cross section of the toner particles is 0.5 or more and 0.8 or less, and an average value of areas of the metal pigment occupying a projected image of the toner particles in a case of being viewed in a thickness direction is 0.5 or more and 0.7 or less, the developing unit developing the electrostatic image formed on the surface of the image holder into a toner image with the electrostatic image developer;
a transfer unit that transfers the toner image onto a recording medium; and
a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at any 50 points by an ultramicrohardness test specified in JIS Z2255 (2003), is 0 or more and 15 or less, the fixing device fixing the toner image onto the recording medium by bringing the surface layer of the fixing member into contact with the toner image on the recording medium and then heating and pressurizing the recording medium,

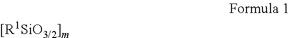

(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group, a plurality of R's may be the same or different from each other,
R² represents a hydrogen atom, a methyl group, or an ethyl group, in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group, the alkyl group, the alkenyl group, the alkynyl group, the aralkyl group, and the aryl group may have a substituent, and
m represents a positive integer).

### BRIEF DESCRIPTION OF THE DRAWINGS

Exemplary embodiment(s) of the present invention will be described in detail based on the following figures, wherein:

FIG. 1 is a schematic cross-sectional view showing an example of a fixing member used in the present exemplary embodiment;

FIG. 2 is a schematic cross-sectional view showing an example of a layer configuration of an electrophotographic photoreceptor used in the present exemplary embodiment;

FIG. 3 is a view schematically showing a configuration of an example of a first exemplary embodiment of a fixing device used in the present exemplary embodiment;

FIG. 4 is a view schematically showing a configuration of an example of a second exemplary embodiment of a fixing device used in the present exemplary embodiment; and

FIG. 5 is a view schematically showing a configuration of an example of an image forming apparatus according to the present exemplary embodiment.

### DETAILED DESCRIPTION

Exemplary embodiments of the present disclosure will be described. The following descriptions and examples merely illustrate the exemplary embodiments, and do not limit the scope of the invention.

In the present specification, a numerical range described using “to” represents a range including numerical values listed before and after “to” as a lower limit value and an upper limit value respectively, in a case where the numerical values are not described as “more than” and “less than”. In addition, a numerical range in a case where the numerical values before and after “to” are described as “more than” or “less than” means a range excluding the numerical values as the lower limit value or the upper limit value.

In numerical ranges described stepwise in the present specification, an upper limit value of a certain numerical range may be replaced with an upper limit value of another numerical range described stepwise, and may be replaced with a value shown in Examples. In addition, a lower limit value of a certain numerical range may be replaced with a lower limit value of another numerical range described stepwise, and may be replaced with a value shown in Examples.

In addition, “%” of a content means “% by mass” unless otherwise specified.

“0 to” as the content (%) means that the component is an optional component and may not be contained.

Each component may include a plurality of kinds of corresponding substances.

In a case where the amount of each component in a composition is mentioned, and there are two or more kinds of substances corresponding to each component in the composition, unless otherwise specified, the amount of each component means the total amount of two or more kinds of the substances present in the composition.

“Step” includes not only an independent step but a step which is not clearly distinguished from other steps as long as the intended action of the step is achieved.

### Image Forming Apparatus

The image forming apparatus according to the exemplary embodiment of the present disclosure includes an image holder, a charging unit that charges a surface of the image holder, an electrostatic image forming unit that forms an electrostatic image on the charged surface of the image holder, a developing unit that accommodates an electrostatic image developer containing a toner and develops the electrostatic image formed on the surface of the image holder into a toner image with the electrostatic image developer, a transfer unit that transfers the toner image onto a recording medium, and a fixing device that fixes the toner image on the recording medium by bringing a surface layer of a fixing member into contact with the toner image on the recording medium and heating and pressurizing the toner image.

The toner contains toner particles. The toner particles contain a metal pigment having an average equivalent circle diameter of 5 μm or more and 15 μm or less, in which an average value of ratios b/a between a major axis diameter a and a minor axis diameter b in a cross section of the toner particles is 0.5 or more and 0.8 or less, and an average value of areas of the metal pigment occupying a projected image of the toner particles in a case of being viewed in a thickness direction is 0.5 or more and 0.7 or less. Hereinafter, the toner particles satisfying these requirements are referred to as “lustrous toner particles”.

In addition, the surface layer of the fixing member contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less. In the surface layer, the difference ΔH between the maximum value and the minimum value of an ultramicrohardness that is measured at any 50 points by an ultramicrohardness test specified in JIS Z2255 (2003) is 0 or more and 15 or less.

The contained ratio (T type/D type) represents a mass ratio.

The image forming apparatus according to the present exemplary embodiment can obtain an image having high luster by the above-described configuration. The reason is presumed as follows.

In the related art, in image formation using a toner, it has been required to form an image having glossiness (that is, luster) such as metallic luster. Therefore, an electrostatic image developing toner containing a metal pigment having a large equivalent circle diameter in toner particles is used. The fact that the equivalent circle diameter is large specifically means that an average equivalent circle diameter is 5 μm or more and 15 μm or less. In addition, in the lustrous toner particles in the present exemplary embodiment, the average value of the ratio b/a and the average value of the area of the metal pigment in the projected image of the toner particles in a case of being viewed from the thickness direction are within the above-described ranges. As a result, a shape of the lustrous toner particles is flattened, and an image having more excellent luster is formed.

Here, in image formation using the lustrous toner particles, a flat lustrous pigment is aligned in a plane direction of the recording medium by pressurization and heating from the fixing member, and thus the luster like a metal glossiness is more exhibited. However, in order to align the lustrous pigment in the plane direction, the lustrous toner particles are heated to a higher temperature and melted than a case of using toner particles other than the lustrous toner particles. Specifically, the lustrous toner particles are heated to a higher temperature by a method of increasing a temperature of the fixing member in contact with the toner particles, reducing a process speed of the fixing device, or the like.

On the other hand, as the temperature of the toner particles is increased during fixing, higher release properties of the fixing member with respect to the toner particles are required. However, as the release properties of the fixing member are increased, an amount of strain applied to the toner is reduced, and the effect of grinding the toner is reduced. As a result, the lustrous pigment is difficult to be aligned along the image, and conversely, the luster of the image may be reduced.

On the other hand, in the image forming apparatus according to the present exemplary embodiment, the surface layer of the fixing member is formed from a cured product of a composition containing the organopolysiloxane (T type) having a silsesquioxane structure and the dimethyl organopolysiloxane (D type) at the above-described contained ratio. Therefore, in the above-described surface layer, the release properties with respect to the toner are ensured, and the flexibility of the surface layer is improved by containing the dimethyl organopolysiloxane (D type). As a result, sufficient pressure is applied to the lustrous toner particles from the fixing member, the lustrous pigment is aligned in the plane direction of the recording medium, and the luster of the image is improved.

Hereinafter, the exemplary embodiment of the present disclosure will be described in more detail.

### Fixing Member

The fixing device includes a fixing member. The fixing member has at least the surface layer, and may further have a base material, and may have an elastic layer between the base material and the surface layer. The fixing member fixes the toner image on the recording medium by bringing the surface layer into contact with the toner image on the recording medium and heating and pressurizing the toner image. A shape of the fixing member may be, for example, a belt shape.

### Surface Layer

The surface layer of the fixing member does not contain a fluorine atom. The fact that the surface layer does not contain a fluorine atom means that a compound containing a fluorine atom (F) in a molecular structure is not contained. Examples of the compound containing a fluorine atom (F) in the molecular structure include fluororesins such as a tetrafluoroethylene/perfluoroalkyl vinyl ether copolymer (PFA), polytetrafluoroethylene (PTFE), a tetrafluoroethylene/hexafluoropropylene copolymer (FEP), polyethylene/tetrafluoroethylene (ETFE), polyvinylidene fluoride (PVDF), polychlorotrifluoroethylene (PCTFE), and polyvinyl fluoride (PVF).

The surface layer is a cured product of a composition (hereinafter, also referred to as “specific composition”) containing the organopolysiloxane (T type) having a silsesquioxane structure represented by Formula 1 and the dimethyl organopolysiloxane (D type). The contained ratio (T type/D type) of the organopolysiloxane (T type) to the dimethyl organopolysiloxane (D type) in the specific composition is 1/9 or more and 9/1 or less.

### Organopolysiloxane (T Type)

The organopolysiloxane (T type) having a silsesquioxane structure represented by Formula 1 will be described.

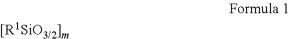

(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group, a plurality of R¹'s may be the same or different from each other,
R² represents a hydrogen atom, a methyl group, or an ethyl group, in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer)

The organopolysiloxane (T type) has only the silsesquioxane structure represented by Formula 1 (that is, the constitutional unit represented by “R¹SiO_{3/2}”) as a constitutional unit constituting a molecular structure.

R¹ is at least one selected from the group consisting of a hydrogen atom, an alkyl group, an alkenyl group, an alkynyl group, an aralkyl group, an aryl group, a group represented by—C(═O)—CR²₃, and a monovalent organic group having a reactive group (hereinafter, also referred to as “polymerizable functional group”). In a case where m is 2 or more, a plurality of R¹'s may be the same or different from each other.

R¹ may be an alkyl group. The alkyl group may be an aliphatic group or an alicyclic group, and may be linear or branched. The number of carbon atoms in the alkyl group is, for example, preferably 1 or more and 10 or less, more preferably 1 or more and 4 or less, still more preferably 1 or more and 2 or less, and particularly preferably 1, that is, a methyl group. Specific examples of the alkyl group having 1 or more and 10 or less carbon atoms include a methyl group, an ethyl group, a propyl group, a butyl group, a pentyl group, a hexyl group, a heptyl group, an octyl group, a nonyl group, and a decyl group.

R¹ may be an alkenyl group. The alkenyl group may be an aliphatic group, an alicyclic group, or an aromatic group, and may be linear or branched. The number of carbon atoms in the alkenyl group is, for example, preferably 1 or more and 10 or less. Specific examples of the alkenyl group having 1 or more and 10 or less carbon atoms include an ethenyl (vinyl) group, an ortho-styryl group, a meta-styryl group, a para-styryl group, a 1-propenyl group, a 2-propenyl (allyl) group, a 1-butenyl group, a 1-pentenyl group, a 3-methyl-1-butenyl group, a phenylethenyl group, an allyl (2-propenyl) group, and an octenyl (7-octen-1-yl) group.

R¹ may be an alkynyl group. The alkynyl group may be an aliphatic group, an alicyclic group, or an aromatic group, and may be linear or branched. The number of carbon atoms in the alkynyl group is, for example, preferably 1 or more and 10 or less. Specific examples of the alkynyl group include an ethynyl group, a 1-propynyl group, a 1-butynyl group, a 1-pentynyl group, a 3-methyl-1-butynyl group, and a phenylbutynyl group.

R¹ may be an aralkyl group. The number of carbon atoms in the aralkyl group is, for example, preferably 7 or more and 20 or less, and more preferably 7 or more and 10 or less. Examples of the aralkyl group having 7 or more and 20 or less carbon atoms include a phenylalkyl group such as a benzyl group.

R¹ may be an aryl group. The number of carbon atoms in the aryl group is, for example, preferably 6 or more and 20 or less, more preferably 6 or more and 10 or less, and still more preferably 6, that is, a phenyl group. Examples of the aryl group having 6 or more and 20 or less carbon atoms include a phenyl group, a 1-naphthyl group, and a 2-naphthyl group.

R¹ may be —C(═O)—CR²₃. R² represents a hydrogen atom, a methyl group, or an ethyl group. R² is, for example, preferably a methyl group. In a case of a plurality of R²'s, the plurality of R²'s may be the same or different from each other.

R¹ may be a monovalent organic group having a reactive group (polymerizable functional group). Examples of the polymerizable functional group include a polymerizable functional group that can be thermoset or photocured. The polymerizable functional group is not particularly limited, and examples thereof include a vinyl group, an allyl group, a styryl group, a methacryloyl group, an acryloyl group, an acryloyloxy group, a methacryloyloxy group, an α-methylstyryl group, a vinyl ether group, a vinyl ester group, an acrylamide group, a methacrylamide group, an N-vinyl amide group, a maleic acid ester group, a fumaric acid ester group, an N-substituted maleimide group, an isocyanate group, an oxetanyl group, and an epoxy group. Among these, as the polymerizable functional group, for example, a polymerizable functional group having a (meth)acryloyl group, an oxetanyl group, or an epoxy group is preferable. The polymerizable functional group may be further substituted with a halogen atom, a hydroxy group, an alkoxy group, an aryloxy group, an aralkyloxy group, or an oxy group.

As the polymerizable functional group having a (meth)acryloyl group, for example, a group represented by the following formula or a group including the group is preferable.

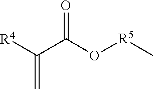

In the formula, R⁴ represents a hydrogen atom or a methyl group, and R⁵ represents an alkylene group having 1 or more and 10 or less carbon atoms. R⁴ is, for example, preferably an alkylene group having 2 or more and 10 or less carbon atoms.

The oxetanyl group is not particularly limited, and examples thereof include a (3-ethyl-3-oxetanyl)methoxy group and a (3-ethyl-3-oxetanyl)oxy group. As the polymerizable functional group having an oxetanyl group, for example, a group represented by the following formula or a group including the group is preferable.

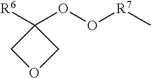

In the formula, R⁶ represents a hydrogen atom or an alkyl group having 1 or more and 6 or less carbon atoms, and R⁷ represents an alkylene group having 1 or more and 6 or less carbon atoms. R⁶ is, for example, preferably a hydrogen atom, a methyl group, an ethyl group, or the like, and more preferably an ethyl group. R⁷ is, for example, preferably an alkylene group having 2 or more and 6 or less carbon atoms, and more preferably a propylene group.

The polymerizable functional group having an epoxy group is not particularly limited, and examples thereof include an alkyl group having 1 or more and 10 or less carbon atoms, that is substituted with a glycidyloxy group, such as β-glycidyloxyethyl, γ-glycidyloxypropyl, and γ-glycidyloxybutyl; and an alkyl group having 5 or more and 10 or less carbon atoms, that is substituted with an oxirane group, such as a glycidyl group, a β-(3,4-epoxycyclohexyl)ethyl group, a γ-(3,4-epoxycyclohexyl)propyl group, a β-(3,4-epoxycycloheptyl)ethyl group, a 4-(3,4-epoxycyclohexyl)butyl group, and a 5-(3,4-epoxycyclohexyl)pentyl group.

The polymerizable functional group may be a functional group having a carbon-carbon double bond or a carbon-carbon triple bond, that can be hydrosilylated with a hydrogen atom (hydrosilyl group) bonded to a silicon atom. The unsaturated organic group can also function as the polymerizable functional group in a sense that the hydrogen atom in the hydrosilyl group polymerizes by a hydrosilylation reaction to form a hydrosilylated structural part. Specific examples of the unsaturated organic group include the above-described alkenyl group, alkynyl group, and the like. The unsaturated organic group is not particularly limited, and examples thereof include a vinyl group, an ortho-styryl group, a meta-styryl group, a para-styryl group, an acryloyl group, a methacryloyl group, an acryloxy group, a methacryloxy group, a 1-propenyl group, a 1-butenyl group, a 1-pentenyl group, a 3-methyl-1-butenyl group, a phenylethenyl group, an ethynyl group, a 1-propynyl group, a 1-butynyl group, a 1-pentynyl group, a 3-methyl-1-butynyl group, a phenylbutynyl group, an allyl(2-propenyl) group, and an octenyl (7-octen-1-yl) group. The unsaturated organic group is, for example, preferably a vinyl group, a para-styryl group, an allyl(2-propenyl) group, or an octenyl (7-octen-1-yl) group, and more preferably a vinyl group.

In the entire organopolysiloxane (T type) having a silsesquioxane structure represented by Formula 1, two or more kinds of polymerizable functional groups may be included. In this case, all the polymerizable functional groups may be the same or different from each other. In addition, the plurality of polymerizable functional groups may be the same and may further include different polymerizable functional groups.

The alkyl group, the alkenyl group, the alkynyl group, the aralkyl group, the aryl group, —C(═O)—CR²₃, and the polymerizable functional group, represented by R¹, may have a substituent. Examples of the substituent include at least one or more of a halogen atom such as a fluorine atom, a chlorine atom, a bromine atom, and an iodine atom; an alkyl group such as a methyl group, an ethyl group, a n-propyl group, an isopropyl group, a n-butyl group, a s-butyl group, an isobutyl group, a tert-butyl group, a n-pentyl group, a n-hexyl group, a n-heptyl group, a n-octyl group, and an isooctyl group; a hydroxy group; an alkoxy group; an aryloxy group; an aralkyloxy group; an oxy group (═O); a cyano group; a protected hydroxyl group; and the like.

A protecting group of the hydroxyl group in the protected hydroxyl group is not particularly limited, and a known hydroxyl group-protecting group is used. Examples of the protecting group include an acyl-based protecting group represented by —C(═O)R (in the formula, R represents an alkyl group having 1 or more and 6 or less carbon atoms, such as a methyl group, an ethyl group, a n-propyl group, an isopropyl group, a n-butyl group, an isobutyl group, a s-butyl group, a tert-butyl group, and an n-pentyl group, or a phenyl group having or not having a substituent; examples of the substituent of the phenyl group having a substituent include an alkyl group such as a methyl group, an ethyl group, a n-propyl group, an isopropyl group, a n-butyl group, a s-butyl group, an isobutyl group, a tert-butyl group, a n-pentyl group, a n-hexyl group, a n-heptyl group, a n-octyl group, and an isooctyl group, a halogen atom such as a fluorine atom, a chlorine atom, and a bromine atom, an alkoxy group such as a methoxy group and an ethoxy group, and the like); a silyl-based protecting group such as a trimethylsilyl group, a triethylsilyl group, a tert-butyldimethylsilyl group, and a tert-butyldiphenylsilyl group; an acetal-based protecting group such as a methoxymethyl group, a methoxyethoxymethyl group, a 1-ethoxyethyl group, a tetrahydropyran-2-yl group, and a tetrahydrofuran-2-yl group; an alkoxycarbonyl-based protecting group such as a t-butoxycarbonyl group; and an ether-based protecting group such as a methyl group, an ethyl group, a tert-butyl group, an octyl group, an allyl group, a triphenylmethyl group, a benzyl group, a p-methoxybenzyl group, a fluorenyl group, a trityl group, and a benzhydryl group.

In Formula 1, at least one of R¹'s is, for example, preferably a methyl group or a phenyl group, and more preferably a methyl group.

The number of silsesquioxane structures represented by Formula 1 in the organopolysiloxane (T type) (that is, the number of m's) is a positive integer.

### Dimethyl Organopolysiloxane (D Type)

The dimethyl organopolysiloxane (D type) has a structure represented by Formula 2.

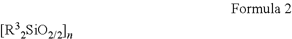

(in Formula 2, R³'s each independently represent a hydrogen atom, an alkyl group, an alkenyl group, an alkynyl group, an aralkyl group, an aryl group, a group represented by —C(═O)—CR²₃, or a monovalent organic group having a reactive group, a plurality of R³'s may be the same or different from each other,
R² represents a hydrogen atom, a methyl group, or an ethyl group, in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
n represents a positive integer)

The dimethyl organopolysiloxane (D type) has only the structure represented by Formula 2 (that is, the constitutional unit represented by “R³₂SiO_{2/2}”) as a constitutional unit constituting a molecular structure.

R³ is at least one selected from the group consisting of a hydrogen atom, an alkyl group, an alkenyl group, an alkynyl group, an aralkyl group, an aryl group, a group represented by —C(═O)—CR²₃, and a monovalent organic group having a reactive group (polymerizable functional group). In a case where n is 2 or more, a plurality of R³'s may be the same or different from each other.

Examples of the aspects of the alkyl group, the alkenyl group, the alkynyl group, the aralkyl group, the aryl group, —C(═O)—CR³₃, and the polymerizable functional group include the same configurations as the various aspects described for “R¹” of Formula 1.

The number of structures represented by Formula 2 in the dimethyl organopolysiloxane (D type) (that is, the number of n's) is a positive integer.

### Contained Ratio (T Type/D Type)

The contained ratio (T type/D type) of the organopolysiloxane (T type) to the dimethyl organopolysiloxane (D type) included in the specific composition is 1/9 or more and 9/1 or less. By setting the contained ratio (T type/D type) to be 1/9 or more, the release properties of the surface layer with respect to the toner are improved. By setting the contained ratio (T type/D type) to 9/1 or less, the flexibility of the surface layer is improved, sufficient pressure is applied to the lustrous toner particles from the fixing member, the lustrous pigment is aligned in the plane direction of the recording medium, and the luster of the image is improved. From the viewpoint of further improving the luster of the image, the contained ratio (T type/D type) is, for example, preferably 3/7 or more and 7/3 or less.

A method of detecting the contained ratio of the organopolysiloxane (T type) and the dimethyl organopolysiloxane (D type) in the specific composition from the surface layer that is a cured product of the specific composition will be described. The contained ratio is calculated by measuring contents of the organopolysiloxane (T type) and the dimethyl organopolysiloxane (D type) by analyzing the surface layer with infrared absorption spectroscopy (IR).

### Surface Layer: Other Additives

The surface layer may contain other additives in addition to the organopolysiloxane (T type) and the dimethyl organopolysiloxane (D type). Examples of the other additives include conductive particles (for example, carbon black), low friction particles (for example, graphite), molybdenum disulfide, and silica particles. A content of each additive can be, for example, 1% by mass or more and 5% by mass or less for the conductive particles, 1% by mass or more and 10% by mass or less for the low friction particles, and 1% by mass or more and 20% by mass or less for the silica particles. In a case where the surface layer contains other additives, the total amount of the organopolysiloxane (T type) and the dimethyl organopolysiloxane (D type) in the surface layer is, for example, preferably 60% by mass or more, and more preferably 80% by mass or more. The total amount of the organopolysiloxane (T type) and the dimethyl organopolysiloxane (D type) in the surface layer may be 100% by mass (that is, the surface layer may not contain other additives).

### Difference ΔH Between Maximum Value and Minimum Value of Ultramicrohardness

In the surface layer, the difference ΔH between the maximum value and the minimum value of an ultramicrohardness that is measured at any 50 points by an ultramicrohardness test specified in JIS Z2255 (2003) is 0 or more and 15 or less. The difference ΔH being equal to or less than the above-described upper limit value means that the organopolysiloxane (T type) and the dimethyl organopolysiloxane (D type) are dispersed in the surface layer and that unevenness of the two is suppressed. Therefore, by setting the difference ΔH to be equal to or less than the above-described upper limit value, the surface layer has improved flexibility while ensuring the release properties with respect to the toner. As a result, sufficient pressure is applied to the lustrous toner particles from the fixing member, the lustrous pigment is aligned in the plane direction of the recording medium, and the luster of the image is improved. From the viewpoint of further improving the luster of the image, the above-described difference ΔH of the surface layer is, for example, preferably 0 or more and 5 or less.

From the viewpoint of controlling the difference ΔH between the maximum value and the minimum value of the ultramicrohardness within the above-described range, for example, it is preferable to use compounds in a solution state at normal temperature (that is, 25° C.) for both the organopolysiloxane (T type) and the dimethyl organopolysiloxane (D type). In addition, for example, it is preferable that the combination of the organopolysiloxane (T type) and the dimethyl organopolysiloxane (D type) is a combination of materials having high compatibility, so that the organopolysiloxane (T type) and the dimethyl organopolysiloxane (D type) are favorably dispersed in a case of being kneaded.

$$Average Value of Ratios B / A \times 100 ( \% )$$

In the surface layer, for example, it is preferable that an average value of ratios B/A×100(%) of an indentation depth B at the time of load release to an indentation depth A at the time of load application in the ultramicrohardness test specified in JIS Z2255 (2003) is 45% or less. The average value of the ratios B/A×100(%) being within the above-described range means that a hysteresis loss in the surface layer is small. In a case where the average value of the ratios B/A×100(%) of the surface layer is equal to or less than the above-described upper limit value, an image having high luster is stably obtained in a case of continuously forming images having luster.

The luster of the image in a case of using the lustrous toner particles is further improved by improving smoothness of the image surface to suppress the scattering of light, in addition to aligning the lustrous pigment in the plane direction of the recording medium. The smoothness of the image surface is affected by smoothness of the surface of the fixing member, that directly comes into contact with the toner image during fixing. However, in a case of using the lustrous toner particles containing the flat lustrous pigment, the lustrous pigment that is exposed from the binding resin constituting the toner particles and that protrudes from the surface of the toner particles may come into contact with the surface of the fixing member during the fixing, resulting in scratches on the fixing member. As a result, the smoothness of the surface of the fixing member is reduced, the smoothness of the surface of the formed image is also reduced, and thus an image having luster may not be stably obtained.

On the other hand, by setting the average value of the ratios B/A×100(%) of the surface layer to be within the above-described range, the hysteresis loss in the surface layer is reduced. Therefore, even in a case where the lustrous pigment exposed from the surface of the toner particles comes into contact with the surface layer of the fixing member, the surface layer is less likely to be scratched. As a result, an image having high luster is stably obtained in a case of continuously forming images having luster.

From the viewpoint of stably obtaining an image having high luster, the average value of the ratios B/A×100(%) of the surface layer is, for example, more preferably 40% or less. In addition, the upper limit value of the average value of the ratios B/A×100(%) of the surface layer is not particularly limited, but is, for example, more preferably 30% or less.

From the viewpoint of controlling the average value of the ratios B/A×100(%) of the surface layer within the above-described range, for example, it is preferable to use compounds in a solution state at normal temperature (that is, 25° C.) for both the organopolysiloxane (T type) and the dimethyl organopolysiloxane (D type). In addition, for example, it is preferable that the combination of the organopolysiloxane (T type) and the dimethyl organopolysiloxane (D type) is a combination of materials having high compatibility, so that the organopolysiloxane (T type) and the dimethyl organopolysiloxane (D type) are favorably dispersed in a case of being kneaded.

### Tensile Elongation Rate

For example, the surface layer preferably has a tensile elongation rate of 100 or more, and more preferably has a tensile elongation rate of 150 or more. The upper limit value of the tensile elongation rate of the surface layer is not particularly limited, but is, for example, preferably 350 or less. By setting the lower limit value of the tensile elongation rate to be within the above-described range, the surface layer has improved flexibility while maintaining the strength, sufficient pressure is applied to the lustrous toner particles from the fixing member, and the luster of the image is improved.

A method of measuring the tensile elongation rate of the surface layer is as follows. The surface layer is cut into 80 mm×5 mm such that a circumferential direction is the long side, and a test is performed at a tensile speed of 20 mm/min with a test piece length between chucks of 40 mm using a tensile tester (MODEL-1605N, manufactured by Aiko Engineering Co., Ltd.) to calculate the tensile elongation rate.

In order to control the tensile elongation rate within the above-described range, for example, the surface layer preferably contains the organopolysiloxane (T type) and the dimethyl organopolysiloxane (D type) in a dispersed state, and unevenness of the two is suppressed. Therefore, for example, it is preferable to use compounds in a solution state at normal temperature (that is, 25° C.) for both the organopolysiloxane (T type) and the dimethyl organopolysiloxane (D type). In addition, for example, it is preferable that the combination of the organopolysiloxane (T type) and the dimethyl organopolysiloxane (D type) is a combination of materials having high compatibility, so that the organopolysiloxane (T type) and the dimethyl organopolysiloxane (D type) are favorably dispersed in a case of being kneaded.

### Surface Roughness of Surface Layer

A surface roughness Ra of an outer peripheral surface of the surface layer, that is, a surface on a side in contact with the toner image is, for example, preferably 1 μm or less, and more preferably 0.5 μm or less. By setting the surface roughness Ra to be within the above-described range, the smoothness of the surface of the formed image is improved, and the luster of the image is further improved. The lower limit value of the surface roughness Ra is not particularly limited, and may be 0 μm.

The surface roughness Ra is obtained as follows. A measurement sample is cut out from the surface layer (or the fixing member having the surface layer). Ra is measured for the measurement sample using a stylus type surface roughness measuring machine (SURFCOM 1400A; manufactured by Tokyo Seimitsu Co., Ltd.). The measurement conditions are in accordance with JIS B 0601-1994, and the evaluation length Ln is set to 2.5 mm, the reference length L is set to 0.8 mm, and the cut-off value is set to 0.008 mm.

### Average Film Thickness of Surface Layer

From the viewpoint of heat transferability of transmitting heat to the toner, an average film thickness of the surface layer is, for example, preferably 30 μm or less, and more preferably 15 μm or more and 25 m or less.

### Method of Forming Surface Layer

As a method of forming the surface layer, for example, first, a specific composition obtained by mixing a liquid organopolysiloxane (T type) and a liquid dimethyl organopolysiloxane (D type) is prepared. The obtained specific composition is dipped in and applied to a cylindrical mold on which the base material of the fixing member is installed, and is cured to form the surface layer on the base material.

### Base Material and Elastic Layer

The fixing member includes at least the surface layer, and may further include a base material. Furthermore, the surface layer may have an elastic layer between the base material and the surface layer.

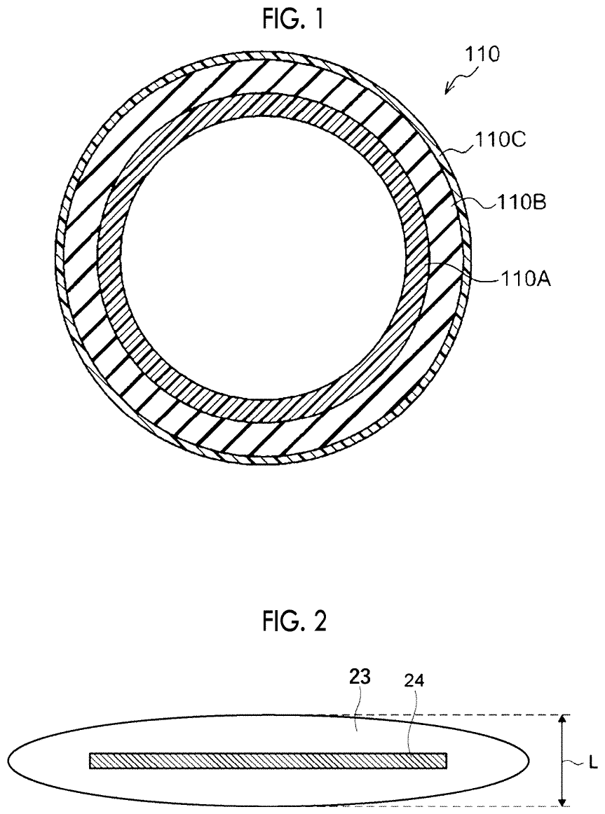

Hereinafter, the fixing member according to the present exemplary embodiment will be described with reference to FIG. 1.

FIG. 1 is a view schematically showing a configuration of an example of the fixing member according to the present exemplary embodiment.

A fixing member 110 shown in FIG. 1 includes a base material layer 110A, an elastic layer 110B provided on the base material layer 110A, and a surface layer 110C provided on the elastic layer 110B.

A layer configuration of the fixing member 110 according to the present exemplary embodiment is not limited to the layer configuration shown in FIG. 1, and the fixing member 110 may not include the elastic layer 110B or may not include the base material layer 110A. The fixing member 110 according to the present exemplary embodiment may have a layer configuration in which a metal layer and a protective layer for the metal layer are interposed between the base material layer 110A and the elastic layer 110B; a layer configuration in which an adhesive layer is interposed between the base material layer 110A and the elastic layer 1101B; a layer configuration in which an adhesive layer is interposed between the elastic layer 110B and the surface layer 110C; or a layer configuration obtained by combining the layer configurations.

Hereinafter, constituent components of the fixing member according to the present exemplary embodiment will be described in detail. The reference numerals will not be provided.

### Base Material Layer

Examples of the base material layer include a resin layer containing a resin such as polyimide. In addition, the base material layer may contain an additive such as a filler in the resin.

Examples of the polyimide include an imidized polyamic acid (polyimide precursor) that is a polymer of a tetracarboxylic dianhydride and a diamine compound. Specific examples of the polyimide include a resin obtained by polymerizing equimolar amounts of a tetracarboxylic dianhydride and a diamine compound in a solvent to obtain a polyamic acid solution, and imidizing the polyamic acid.

Examples of the tetracarboxylic dianhydride include an aromatic tetracarboxylic dianhydride compound and an aliphatic tetracarboxylic dianhydride compound; and from the viewpoint of heat resistance, for example, an aromatic tetracarboxylic dianhydride compound is preferable.

Examples of the aromatic tetracarboxylic dianhydride include pyromellitic dianhydride, 3,3′,4,4′-benzophenone tetracarboxylic dianhydride, 3,3′,4,4′-biphenylsulfone tetracarboxylic dianhydride, 1,4,5,8-naphthalenetetracarboxylic dianhydride, 2,3,6,7-naphthalenetetracarboxylic dianhydride, 3,3′,4,4′-biphenyl ether tetracarboxylic dianhydride, 3,3′,4,4′-dimethyldiphenylsilane tetracarboxylic dianhydride, 3,3′,4,4′-tetraphenylsilane tetracarboxylic dianhydride, 1,2,3,4-furane tetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidene diphthalic dianhydride, 3,3′,4,4′-biphenyltetracarboxylic dianhydride, 2,3,3′,4′-biphenyltetracarboxylic dianhydride, bis(phthalic)phenylphosphine oxide dianhydride, p-phenylene-bis(triphenylphthalic)dianhydride, m-phenylene-bis(triphenylphthalic)dianhydride, bis(triphenylphthalic)-4,4′-diphenyl ether dianhydride, and bis(triphenylphthalic)-4,4′-diphenylmethane dianhydride.

Examples of the aliphatic tetracarboxylic dianhydride include aliphatic or alicyclic tetracarboxylic dianhydrides such as butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic acid dianhydride, 3,5,6-tricarboxynorbornane-2-acetic acid dianhydride, 2,3,4,5-tetrahydrofuran tetracarboxylic dianhydride, 5-(2,5-dioxotetrahydrofuryl)-3-methyl-3-cyclohexene-1,2-dicarboxylic acid dianhydride, and bicyclo [2,2,2]-oct-7-ene-2,3,5,6-tetracarboxylic dianhydride; and aliphatic tetracarboxylic dianhydrides having an aromatic ring, such as 1,3,3a,4,5,9b-hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione.

Among these, as the tetracarboxylic dianhydride, for example, an aromatic tetracarboxylic dianhydride is preferable, and specifically, for example, pyromellitic dianhydride, 3,3′,4,4′-biphenyltetracarboxylic dianhydride, 2,3,3′,4′-biphenyltetracarboxylic dianhydride, 3,3′,4,4′-biphenylethertetracarboxylic dianhydride, or 3,3′,4,4′-benzophenonetetracarboxylic dianhydride is preferable; pyromellitic dianhydride, 3,3′,4,4′-biphenyltetracarboxylic dianhydride, or 3,3′,4,4′-benzophenonetetracarboxylic dianhydride is more preferable; and 3,3′,4,4′-biphenyltetracarboxylic dianhydride is particularly preferable.

The tetracarboxylic dianhydride may be used alone, or two or more kinds thereof may be used in combination.

In a case where two or more tetracarboxylic dianhydrides are used in combination, either aromatic tetracarboxylic dianhydrides or aliphatic tetracarboxylic dianhydrides may be used in combination, or an aromatic tetracarboxylic dianhydride and an aliphatic tetracarboxylic dianhydride may be used in combination.

Meanwhile, the diamine compound is a diamine compound having two amino groups in the molecular structure. Examples of the diamine compound include an aromatic diamine compound and an aliphatic diamine compound, and for example, an aromatic diamine compound is preferable.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindan, 6-amino-1-(4′-aminophenyl)-1,3,3-trimethylindan, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)biphenyl, 1,3′-bis(4-aminophenoxy)benzene, 9,9-bis(4-aminophenyl)fluorene, 4,4′-(p-phenylene isopropylidene)bisaniline, 4,4′-(m-phenylene isopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamines having two amino groups bonded to an aromatic ring and a heteroatom other than a nitrogen atom of the amino groups, such as diaminotetraphenylthiophene; and aliphatic diamines and alicyclic diamines such as 1,1-m-xylylenediamine, 1,3-propane diamine, tetramethylenediamine, pentamethylenediamine, octamethylenediamine, nonamethylenediamine, 4,4-diaminoheptamethylenediamine, 1,4-diaminocyclohexane, isophorone diamine, tetrahydrodicyclopentadienylenediamine, hexahydro-4,7-methanoin danylene dimethylenediamine, tricyclo[6,2,1,0^{2.7}]-undecylene dimethyldiamine, and 4,4′-methylenebis(cyclohexylamine).

Among these, as the diamine compound, for example, an aromatic diamine compound is preferable, and specifically, for example, p-phenylenediamine, m-phenylenediamine, 4,4′-diaminodiphenylmethane, 4,4′-diaminodiphenylether, 3,4′-diaminodiphenylether, 4,4′-diaminodiphenylsulfide, or 4,4′-diaminodiphenylsulfone is preferable, and 4,4′-diaminodiphenylether or p-phenylenediamine is particularly preferable.

The diamine compound may be used alone, or two or more kinds thereof may be used in combination.

In a case where two or more diamine compounds are used in combination, either aromatic diamine compounds or aliphatic diamine compounds may be used in combination, or an aromatic diamine compound and an aliphatic diamine compound may be combined.

Among these, from the viewpoint of heat resistance, as the polyimide, for example, an aromatic polyimide (specifically, an imidized polyamic acid (polyimide precursor) that is a polymer of the aromatic tetracarboxylic dianhydride and the aromatic diamine compound) is preferable.

The aromatic polyimide is, for example, more preferably a polyimide having a structural unit represented by General Formula (PI1).

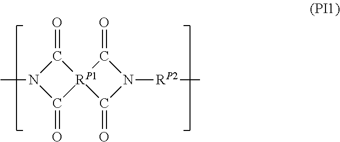

In General Formula (PI1), R^{P1} represents a phenyl group or a biphenyl group, and R^{P2} represents a divalent aromatic group.

Examples of the divalent aromatic group represented by R^{P2} include a phenylene group, a naphthyl group, a biphenyl group, and a diphenyl ether group. As the divalent aromatic group, from the viewpoint of bending durability, for example, a phenylene group or a biphenyl group is preferable.

A number-average molecular weight of the polyimide is, for example, preferably 5,000 or more and 100,000 or less, more preferably 7,000 or more and 50,000 or less, and still more preferably 10,000 or more and 30,000 or less.

The number-average molecular weight of the polyimide is measured by gel permeation chromatography (GPC) under the following measurement conditions.
Column: Tosoh TSK gel α-M (7.8 mm I.D×30 cm)
Eluent: dimethylformamide (DMF)/30 mM LiBr/60 mM phosphoric acid. Flow velocity: 0.6 mL/min
Injection amount: 60 L
Detector: RI (differential refractive index detector)

Examples of the filler include carbon materials such as acetylene black, graphite, graphitized carbon black, and non-graphitized carbon black; and metal nitrides such as aluminum nitride, silicon nitride, boron nitride, cerium oxide, and magnesium carbonate.

As necessary, the base material layer may further contain other additives in addition to the polyimide and filler described above. Examples of the other additives include a softener (paraffin-based softener and the like), a processing aid (stearic acid and the like), an aging inhibitor (amine-based aging inhibitor and the like), and a vulcanizing agent (sulfur, a metal oxide, a peroxide, and the like).

From the viewpoint of thermal conductivity, mechanical strength, and the like, a film thickness of the base material layer is, for example, preferably 30 μm or more and 200 μm or less, and particularly preferably 50 μm or more and 150 μm or less.

The base material layer is obtained by preparing a coating liquid for forming a base material layer, that contains the polyimide (further containing an additive such as a filler), applying the coating liquid for forming a base material layer onto a cylindrical mold, and drying the coating liquid.

### Elastic Layer

The elastic layer contains an elastic material. The elastic layer may contain known additives in addition to the elastic material.

Examples of the elastic material include a fluororesin, a silicone resin, silicone rubber, fluororubber, and fluorosilicone rubber. Among the above, as the elastic material, from the viewpoint of heat resistance, thermal conductivity, insulating properties, and the like, for example, silicone rubber or fluororubber is preferable, and silicone rubber is more preferable.

Examples of the silicone rubber include RTV silicone rubber, HTV silicone rubber, and liquid silicone rubber; and specific examples thereof include polydimethyl silicone rubber (MQ), methyl vinyl silicone rubber (VMQ), methyl phenyl silicone rubber (PMQ), and fluorosilicone rubber (FVMQ).

As the silicone rubber, for example, silicone rubber that is crosslinked generally by an addition reaction is preferable. In addition, various types of functional groups are known for silicone rubber, and for example, dimethyl silicone rubber having a methyl group, methyl phenyl silicone rubber having a methyl group and a phenyl group, vinyl silicone rubber having a vinyl group (vinyl group-containing silicone rubber), or the like is preferable.

Furthermore, as the silicone rubber, for example, vinyl silicone rubber having a vinyl group is more preferable, and silicone rubber that has an organopolysiloxane structure having a vinyl group and a hydrogen organopolysiloxane structure having a hydrogen atom bonded to a silicon atom (SiH) is still more preferable.

Examples of the fluororubber include vinylidene fluoride-based rubber, tetrafluoroethylene/propylene-based rubber, tetrafluoroethylene/perfluoromethyl vinyl ether rubber, phosphazene-based rubber, and fluoropolyether rubber.

For example, it is preferable that the elastic material contains silicone rubber as a principal component (that is, a content of the silicone rubber is, for example, preferably 50% by mass or more with respect to the total mass of the elastic material).

The content of the silicone rubber is, for example, more preferably 90% by mass or more, and still more preferably 99% by mass or more with respect to the total mass of the elastic material used in the elastic layer, and the content of the silicone rubber may be 100% by mass.

The elastic layer may contain additives such as a filler, a softener (such as a paraffin-based softener), a processing aid (such as stearic acid), an antioxidant (such as an amine-based antioxidant), and a vulcanizing agent (such as sulfur, a metal oxide, or a peroxide).

The elastic layer may be formed by a known method, and for example, a coating method is used.

In a case where the silicone rubber is used as the elastic material of the elastic layer, for example, first, a coating liquid for forming an elastic layer, that contains liquid silicone rubber that turns into silicone rubber by being cured by heating, is prepared. Next, the base material layer is coated with the coating liquid for forming an elastic layer to form a coating film, and the coating film is vulcanized as necessary, thereby forming an elastic layer on the base material layer. During the vulcanization of the coating film, a vulcanization temperature is, for example, 150° C. or higher and 250° C. or lower, and the vulcanization time is, for example, 30 minutes or longer and 120 minutes or shorter.

### Average Film Thickness of Elastic Layer

From the viewpoint that sufficient pressure is applied to the lustrous toner particles from the fixing member and the luster of the image is improved, an average film thickness of the elastic layer is, for example, preferably 300 μm or more, and more preferably 400 μm or more and 500 μm or less.

### Developer

The electrostatic image developer contains a toner, and the toner contains toner particles. The toner particles contain a metal pigment having an average equivalent circle diameter of 5 μm or more and 15 μm or less, in which an average value of ratios b/a between a major axis diameter a and a minor axis diameter b in a cross section of the toner particles is 0.5 or more and 0.8 or less, and an average value of areas of the metal pigment occupying a projected image of the toner particles in a case of being viewed in a thickness direction is 0.5 or more and 0.7 or less.

### Average Value of Ratio b/a

In the lustrous toner particles, the average value of the ratio b/a of the minor axis diameter b to the major axis diameter a in a cross section thereof is 0.5 or more and 0.8 or less. The average value of the ratio b/a is, for example, preferably 0.55 or more and 0.75 or less, and more preferably 0.6 or more and 0.7 or less.

In a case where the average value of the ratio b/a is less than 0.5, coating property of the metal pigment by the binding resin may be deteriorated. On the other hand, in a case where the average value of the ratio b/a is more than 0.8, luster of a fixed image may be decreased.

In the present exemplary embodiment, a method of measuring the major axis diameter a and the minor axis diameter b in the cross section of the toner particles is as follows. The toner particles are placed on a smooth surface and vibrated to be dispersed without unevenness. For 1,000 toner particles, by magnifying the toner particles 1,000 times with a color laser microscope “VK-9700” (manufactured by KEYENCE CORPORATION), the maximum thickness is defined as the minor axis diameter b and an equivalent circle diameter of a surface as viewed from above is defined as the major axis diameter a; and an arithmetic average value thereof is calculated.

### Pigment Area Ratio

In the lustrous toner particles, the average value of the area of the metal pigment in the projected image of the toner particles in a case where the toner particles are viewed in the thickness direction is also referred to as “pigment area ratio” in the present specification. In the lustrous toner particles, the pigment area ratio is 0.5 or more and 0.7 or less. The pigment area ratio is, for example, preferably 0.53 or more and 0.67 or less, and more preferably 0.57 or more and 0.63 or less. In a case where the pigment area ratio is less than 0.5, the luster of the fixed image may be decreased. In a case where the pigment area ratio is more than 0.7, the coating property of the metal pigment by the binding resin may be deteriorated.

In the present exemplary embodiment, a method of measuring the pigment area ratio is as follows. An arithmetic average of pigment area ratios of 1,000 toner particles obtained as described below is defined as the pigment area ratio in the present exemplary embodiment. The toner particles are dispersed in water using a surfactant. For 1,000 toner particles, a light transmission image obtained by an optical microscope “LABOPHOT2” (manufactured by Nikon Corporation) is subjected to image analysis, an area A of the entire toner and an area B of the lustrous pigment portion inside the toner are obtained, and B/A is calculated.

### Ratio (X/Y)

In a case where a solid image is formed with the electrostatic image developing toner containing the lustrous toner particles, for example, it is desirable that a ratio (X/Y) of a reflectivity X at a light-receiving angle of +30° to a reflectivity Y at a light-receiving angle of −30° is 2 or more and 100 or less, the reflectivity X and the reflectivity Y being measured in a case where the image is irradiated with light having an incidence angle of −45° by a goniophotometer.

The fact that the ratio (X/Y) is 2 or more means that the amount of light reflected to a side (angle+ side) opposite to a side on which light is incident is larger than the amount of light reflected to the side (angle − side) on which the light is incident, that is, diffuse reflection of the incident light is suppressed. In a case where the diffuse reflection occurs in which incident light is reflected in various directions, the reflected light appears to be dull in color upon visual observation. Therefore, in a case where the ratio (X/Y) is less than 2, glossiness may not be observed even in a case where the reflected light is visually recognized, and the luster may be deteriorated.

On the other hand, in a case where the ratio (X/Y) is more than 100, an angle of view in which the reflected light can be visually recognized is excessively narrowed, and a specular reflection light component is large, so that the reflected light may appear dark depending on the angle of view.

The ratio (X/Y) is, for example, more desirably 50 or more and 100 or less, still more desirably 60 or more and 90 or less, and particularly desirably 70 or more and 80 or less.

### Measurement of Ratio (X/Y) by Goniophotometer

Here, first, the incidence angle and the light-receiving angle will be described. In the measurement with the goniophotometer in the present exemplary embodiment, the incidence angle is set to −45°. This is because a measurement sensitivity is high for an image having a wide range of glossiness.

In addition, the light-receiving angle is set to −30° and +30°. This is because the measurement sensitivity is the highest for evaluating an image with brilliance and an image without brilliance.

Next, a method of measuring the ratio (X/Y) will be described.

In the present exemplary embodiment, in a case of measuring the ratio (X/Y), first, “solid image” is formed by the following method. A developer as a sample is filled in a developing machine of DocuCentre-III C7600 manufactured by FUJIFILM Business Innovation Corp., and a solid image with a toner coverage of 4.5 g/m² is formed on recording paper (OK topcoat+ paper, manufactured by Oji Paper Co., Ltd.) at a fixing temperature of 190° C. and a fixing pressure of 4.0 kg/cm². The “solid image” refers to an image having a printing rate of 100%.

Using a spectroscopic variable angle reflectometer GC5000L manufactured by NIPPON DENSHOKU INDUSTRIES Co., Ltd. as the goniophotometer, incident light at an incidence angle of −45° is incident on an image area of the formed solid image, and the reflectivity X at a light-receiving angle of +30° and the reflectivity Y at a light-receiving angle of −30° are measured. The reflectivity X and the reflectivity Y are measured at intervals of 20 nm for light having a wavelength in a range of 400 nm to 700 nm, and an average value of the reflectivity at each wavelength is used. From these measurement results, the ratio (X/Y) is calculated.

### Configuration of Toner

From the viewpoint of satisfying the above-described ratio (X/Y), for example, it is desirable that the lustrous toner particles satisfy the following requirements (1) and (2).

(1) an average equivalent circle diameter D is longer than an average maximum thickness C of the lustrous toner particles.

(2) in a case where a cross section of the lustrous toner particles in a thickness direction is observed, the number of metal pigments in which an angle between a major axis direction of the toner in the cross section and a major axis direction of the metal pigment is in a range of −30° to +30° is 60% or more of all metal pigments to be observed.

The average maximum thickness C of the toner corresponds to an arithmetic average of the minor axis diameters b in the cross section of the toner particles. The average equivalent circle diameter D of the toner corresponds to an arithmetic mean of the major axis diameters a in the cross section of the toner particles.

Here, FIG. 2 shows a cross-sectional view schematically showing the lustrous toner particle satisfying the above-described requirements (1) and (2). The schematic view shown in FIG. 2 is a cross-sectional view of the lustrous toner particle in the thickness direction.

A lustrous toner particle 23 shown in FIG. 2 is flat-shaped toner having an equivalent circle diameter longer than a thickness L, and contains a scale-like metal pigment 24.

As shown in FIG. 2, a case where the lustrous toner particle 23 has a flat shape in which the equivalent circle diameter is longer than the thickness L is considered. In this case, in a developing step or a transferring step of image formation, in a case where the toner moves to an image holder, an intermediate transfer body, a recording medium, or the like, the toner tends to move in a manner of maximally canceling a charge of the toner. Therefore, it is considered that the lustrous toner particles are arranged such that an area to be attached is maximized. That is, it is considered that the flat lustrous toner particles are arranged on the recording medium to which the toner is finally transferred, such that a flat surface side of the flat lustrous toner particles faces the surface of the recording medium. In addition, even in a fixing step of the image formation, it is considered that the flat lustrous toner particles are arranged such that the flat surface side of the flat lustrous toner particles faces the surface of the recording medium due to pressure during fixing.

Therefore, it is considered that metal pigments satisfying the requirement that “the angle between the major axis direction of the lustrous toner particles in the cross section and the major axis direction of the metal pigment is in a range of −30° to +30°” described in (2) above among the scale-like metal pigments contained in the lustrous toner particles are arranged such that the surface side having the maximum area faces the surface of the recording medium. In a case where the image thus formed is irradiated with light, it is considered that the above-described ratio (X/Y) is achieved because the proportion of the metal pigment that is irregularly reflected with respect to the incident light is suppressed. In addition, in a case where the proportion of the metal pigment that diffuses the incident light is suppressed, the intensity of reflected light changes greatly depending on the viewing angle, and thus more ideal luster can be obtained.

Next, components constituting the toner used in the present exemplary embodiment will be described.

The toner used in the present exemplary embodiment is configured to contain toner particles, and external additives that are used as necessary.

As the toner particles, the lustrous toner particles satisfying the above-described requirements are used. The toner particles are configured to contain, for example, the specific metal pigment, a binding resin, a release agent, and other additives. The binding resin includes, for example, a crystalline resin and an amorphous resin.

### Metal Pigment

The metal pigment used in the lustrous toner particles of the present exemplary embodiment is a metal pigment having an average equivalent circle diameter of 5 μm or more and 15 μm or less. In a case where the average equivalent circle diameter of the metal pigment is outside the range of 5 μm or more and 15 μm or less, the luster of the image may decrease.

The average equivalent circle diameter of the metal pigment is, for example, preferably 7 μm or more and 13 μm or less, and more preferably 9 μm or more and 11 μm or less.

Examples of a component of the metal pigment used in the present exemplary embodiment include the following components. For example, a metal-containing pigment with luster may be used without particular limitation, and examples thereof include metal powder such as aluminum, brass, bronze, nickel, stainless steel, and zinc; coated flake-like inorganic crystal substrates such as mica coated with titanium oxide or yellow iron oxide, barium sulfate, layered silicate, and layered aluminum silicates; single crystal plate-like titanium oxide, basic carbonates, bismuth oxychloride, and flake-like glass powder subjected to metal vapor deposition. In the present exemplary embodiment, the “luster” represents that an image formed by the toner of the present exemplary embodiment has brightness such as metallic glossiness in a case where the image is visually recognized.

In the present exemplary embodiment, the average equivalent circle diameter of the metal pigment refers to a value measured as follows.

The metal pigment is placed on a smooth surface and vibrated to be dispersed without unevenness. For 1,000 μmetal pigments, by magnifying the metal pigments 1,000 times with a color laser microscope “VK-9700” (manufactured by KEYENCE CORPORATION), an equivalent circle diameter D of a surface of the metal pigment as viewed from above is measured, and an arithmetic average value thereof is calculated.

A method of extracting the metal pigment from the toner is not particularly limited. For example, the metal pigment is extracted from the toner by the following method.

The metal pigment is extracted by dispersing the toner in an organic solvent such as toluene to dissolve the binding resin, separating insoluble components with filter paper, and then drying the resultant.

A content of the above-described metal pigment in the toner of the present exemplary embodiment is, for example, preferably 1 part by mass or more and 70 parts by mass or less with respect to 100 parts by mass of the binding resin described later. The content thereof is, for example, more preferably 5 parts by mass or more and 50 parts by mass or less.

### Binding Resin

The toner particles of the present exemplary embodiment may contain a binding resin. As the binding resin, for example, it is preferable to contain a binding resin including a crystalline resin and an amorphous resin.

In the present exemplary embodiment, a proportion of the crystalline resin in the binding resin is, for example, preferably 3% by mass or more and 30% by mass or less. The proportion thereof is, for example, more preferably 5% by mass or more and 25% by mass or less, and still more preferably 10% by mass or more and 20% by mass or less. In a case where the proportion of the crystalline resin in the binding resin is 3% by mass or more, rub resistance of the toner image is improved. In a case where the proportion of the crystalline resin in the binding resin is 30% by mass or less, an increase in the diffuse reflection of the image due to the presence of the crystalline resin is suppressed.

Examples of the binding resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binding resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

As the binding resin, for example, a polyester resin is suitable.

Examples of the polyester resin include known amorphous polyester resins. As the polyester resin, a crystalline polyester resin may be used in combination with an amorphous polyester resin.

The “crystalline” resin indicates that a clear endothermic peak is present in differential scanning calorimetry (DSC) rather than a stepwise change in endothermic amount and specifically indicates that the half-value width of the endothermic peak in a case of measurement at a temperature rising rate of 10 (° C./min) is within 10° C.

On the other hand, the “amorphous” resin indicates that the half-value width is higher than 10° C., a stepwise change in endothermic amount is shown, or a clear endothermic peak is not recognized.

### Amorphous Polyester Resin

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, orthophthalic acid, naphthalenedicarboxylic acid, and the like), anhydrides of these, and lower alkyl esters (for example, having 1 or more and 5 or less carbon atoms). Among the polyvalent carboxylic acids, for example, aromatic dicarboxylic acid is preferable.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K-7121-1987, “Testing methods for transition temperatures of plastics”.

The weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC HLC-8120GPC manufactured by Tosoh Corporation as a measurement device, TSKgel Super HM-M (15 cm) manufactured by Tosoh Corporation as a column, and tetrahydrofuran (THF) as a solvent. The weight-average molecular weight and the number-average molecular weight are calculated using a molecular weight calibration curve plotted using a monodisperse polystyrene standard sample from the measurement results.

The amorphous polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the copolymerization reaction, for example, the monomer with poor compatibility may be condensed in advance with an acid or an alcohol that is to be polycondensed with the monomer, and then polycondensed together with the main component.

### Crystalline Polyester Resin

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 2 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-icosanediol. Among the aliphatic diols, for example, 1,6-hexanediol, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, and pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

The melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The weight-average molecular weight (Mw) of the crystalline polyester resin is, for example, preferably 6,000 or more and 35,000 or less.

The crystalline polyester resin can be obtained by a known manufacturing method, for example, same as the amorphous polyester resin.

A content of the binding resin with respect to the total amount of the toner particles is, for example, preferably 40% by mass or more and 95% by mass or less, more preferably 50% by mass or more and 90% by mass or less, and still more preferably 60% by mass or more and 90% by mass or less.

### Release Agent

Examples of the release agent include hydrocarbon-based wax; natural wax such as carnauba wax, rice wax, and candelilla wax; synthetic, mineral, or petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K-7121-1987, “Testing methods for transition temperatures of plastics”.

The content of the release agent with respect to the total amount of the toner particles is, for example, preferably 1% by mass or more and 20% by mass or less, and more preferably 4% by mass or more and 15% by mass or less.

### Other Additives

Examples of other additives include well-known additives such as a magnetic material, a charge control agent, and inorganic powder. The additives are incorporated into the toner particles as internal additives.

Characteristics and the like of Lustrous Toner Particles

The lustrous toner particles may be toner particles that have a single-layer structure or toner particles having a so-called core/shell structure that is configured with a core portion (core particle) and a coating layer (shell layer) coating the core portion.

Here, the toner particles having a core/shell structure may, for example, be configured with a core portion that is configured with the binding resin, the metal pigment (colorant), and other additives used as necessary, such as a release agent, and a coating layer that is configured with the binding resin.

A volume average particle diameter (D50v) of the lustrous toner particles is, for example, preferably 5 μm or more and 30 μm or less.

Various average particle diameters and various particle size distribution indexes of the toner particles are measured using COULTER MULTISIZER 4e (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle diameter in a range of 2 μm or more and 60 μm or less is measured using COULTER MULTISIZER 4e with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume average particle diameter D16v and a number-based particle size D16p. The particle size at which the cumulative percentage of particles is 50% is defined as volume average particle diameter D50v and a cumulative number-average particle size D50p. The particle size at which the cumulative percentage of particles is 84% is defined as volume average particle diameter D84v and a number-based particle size D84p.

By using these, a volume average particle size distribution index (GSDv) is calculated as (D84v/D16v)^{1/2}, and a number average particle size distribution index (GSDp) is calculated as (D84p/D16p)^{1/2}.

A shape factor SF1 of the lustrous toner particles is, for example, preferably 110 or more and 150 or less, and more preferably 120 or more and 140 or less.

The shape factor SF1 is obtained by the following equation.

$$SF 1 = ( M {L}^{2} / A ) \times ( π / 4 ) \times 100 \qquad Equation$$

In the above equation, ML represents the absolute maximum length of the toner, and A represents the projected area of the toner.

Specifically, the shape factor SF1 is quantified generally by analyzing a microscopic image or a scanning electron microscopic (SEM) image using an image analyzer, and is calculated as follows. That is, the shape factor SF1 is obtained by capturing an optical microscopic image of particles scattered on the surface of a slide glass into a LUZEX image analyzer with a video camera, obtaining the maximum length and the projected area of 100 particles, and calculating with the above-described equation to obtain an average value thereof.

Angle Between Major Axis Direction of Lustrous Toner Particles in Cross Section and Major Axis Direction of Metal Pigment

As shown in (2) above, in a case where a cross section of the lustrous toner particles in a thickness direction is observed, for example, it is desirable that the number of metal pigments in which an angle between a major axis direction of the toner particles in the cross section and a major axis direction of the metal pigment is in a range of −30° to +30° is 60% or more of all metal pigments to be observed. Furthermore, the above-described number is, for example, more desirably 70% or more and 95% or less, and particularly desirably 80% or more and 90% or less.

In a case where the above-described number is 60% or more, excellent luster is obtained.

Here, a method of observing the cross section of the toner particles will be described.

The toner particles are embedded in a bisphenol A-type liquid epoxy resin and a curing agent, and a cutting sample is produced. Next, the cutting sample is cut under −100° C. using a cutting machine using a diamond knife (in the present exemplary embodiment, a LEICA ultramicrotome (manufactured by Hitachi Technologies Corporation) is used), and an observation sample is produced. The cross section of the toner particles in the observation sample is observed with a transmission electron microscope (TEM) at a magnification of approximately 5,000 times. For 1,000 observed toner particles, the number of metal pigments in which the angle between the major axis direction of the toner particles in the cross section and the major axis direction of the metal pigment is in a range of −30° to +300 is counted using image analysis software, and a proportion thereof is calculated.

The “major axis direction of the toner particles in the cross section” represents a direction orthogonal to the thickness direction of the toner particles having an average equivalent circle diameter D longer than the average maximum thickness C described above, and the “major axis direction of the metal pigment” represents a length direction of the metal pigment.

### External Additive

Examples of the external additive include inorganic particles. Examples of the inorganic particles include SiO₂, TiO₂, Al₂O₃, SrTiO₃, CaTiO₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobization treatment. The hydrophobization treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning lubricant (for example, a metal salt of a higher fatty acid represented by zinc stearate or higher alcohols).

The amount of the external additive externally added with respect to the toner particles is, for example, preferably 0.01% by mass or more and 10.0% by mass or less, and more preferably 0.01% by mass or more and 6.0% by mass or less.

The toner of the present exemplary embodiment may be produced by adding an external additive to the toner particles after the toner particles are manufactured.

A method for manufacturing the toner particles is not particularly limited, and the toner particles are produced by a known dry method such as a kneading and pulverization method, a wet method such as a coagulation method, a suspension polymerization method, and a dissolution suspension method, or the like.

The kneading and pulverization method is a method in which each material including the binding resin is mixed, the material is melt-kneaded using a kneader, an extruder, or the like, the obtained melt-kneaded product is coarsely pulverized, and then pulverized with a jet mill or the like, and the toner particles having a target particle diameter are obtained by a wind power classifier.

Among these methods, for example, a coagulation method is desirable because the shape of the toner particles and the particle diameter of the toner particles are easily controlled and the control range of the toner particle structure such as a core-shell structure is wide. In addition, from the viewpoint that the shape of the toner particles and the particle diameter of the toner particles can be easily controlled and the toner resin can be coated on the pigment in a state in which unevenness is suppressed, for example, the coagulation method is desirable.

Hereinafter, a method for manufacturing the toner particles by the coagulation method will be described in detail.

The coagulation method includes an emulsification step of emulsifying raw materials constituting the toner particles to form resin particles (emulsified particles) and the like, an aggregation step of forming an aggregate of the resin particles, and a fusion step of fusing the aggregates.

### Emulsification Step

In production of a resin particle dispersion, in addition to the production of the resin particle dispersion by a general polymerization method, for example, an emulsion polymerization method, a suspension polymerization method, a dispersion polymerization method, or the like, the resin particle dispersion may be produced by emulsifying a solution obtained by mixing an aqueous medium and a binding resin with a disperser to apply a shearing force. In this case, viscosity of the resin component may be lowered by heating to form particles. In addition, a dispersant may be used for stabilizing the dispersed resin particles. Furthermore, in a case where the resin is dissolved in an oily solvent having a relatively low solubility in water, the resin is dissolved in the solvent, and the resin is dispersed in water together with a dispersant or a polymer electrolyte to disperse the resin particles, and then the solvent is evaporated by heating or depressurization, thereby producing the resin particle dispersion.

Examples of the aqueous medium include water such as distilled water and deionized water, and alcohols, but water is desirable.

In addition, examples of the dispersant used in the emulsification step include water-soluble polymers such as polyvinyl alcohol, methyl cellulose, ethyl cellulose, hydroxyethyl cellulose, carboxymethyl cellulose, sodium polyacrylate, and sodium polymethacrylate; anionic surfactants such as sodium dodecylbenzene sulfonate, sodium octadecyl sulfate, sodium oleate, sodium laurate, and potassium stearate; cationic surfactants such as laurylamine acetate, stearylamine acetate, and lauryltrimethylammonium chloride; amphoteric surfactants such as laurydimethylamine oxide; nonionic surfactants such as polyoxyethylene alkyl ether, polyoxyethylene alkylphenyl ether, and polyoxyethylene alkylamine; and inorganic salts such as tricalcium phosphate, aluminum hydroxide, calcium sulfate, calcium carbonate, and barium carbonate.

Examples of the disperser used for the production of the above-described emulsified liquid include a homogenizer, a homomixer, a pressurized kneader, an extruder, and a media disperser. As a size of the resin particles, an average particle diameter (volume-average particle diameter) of the resin particles is, for example, desirably 1.0 μm or less, more desirably in a range of 60 nm or more and 300 nm or less, and still more desirably in a range of 150 nm or more and 250 nm or less. In a case where the average particle diameter thereof is 60 nm or more, the resin particles are likely to be unstable particles in the dispersion, and thus the resin particles may be easily aggregated. In addition, in a case where the average particle diameter thereof is 1.0 μm or less, a particle diameter distribution of the toner may be narrowed.

In preparation of a release agent dispersion, the release agent is dispersed in water together with an ionic surfactant or a polymeric electrolyte such as a polymeric acid and a polymeric base, heated to a temperature equal to or higher than a melting temperature of the release agent, and then subjected to a dispersion treatment using a homogenizer or a pressure jetting type disperser, that applies a strong shearing force. By undergoing such a treatment, a release agent dispersion is obtained. In the dispersion treatment, an inorganic compound such as polyaluminum chloride may be added to the dispersion. Examples of a desired inorganic compound include polyaluminum chloride, aluminum sulfate, highly basic polyaluminum chloride (BAC), polyaluminum hydroxide, and aluminum chloride. Among the above, for example, polyaluminum chloride, aluminum sulfate, or the like is desirable. The above-described release agent dispersion is used in the coagulation method, but the above-described release agent dispersion may also be used in a case where the toner is manufactured by the suspension polymerization method.

By the dispersion treatment, a release agent dispersion containing release agent particles having a volume-average particle diameter of 1 μm or less is obtained. The volume-average particle diameter of the release agent particles is, for example, more desirably 100 nm or more and 500 nm or less.

In a case where the volume-average particle diameter thereof is 100 nm or more, characteristics of the binding resin to be used are also affected, but the release agent component is generally easily incorporated into the toner. In addition, in a case where the volume-average particle diameter thereof is 500 nm or less, a dispersion state of the release agent in the toner is improved.

A known dispersion method can be used for preparing a colorant (metal pigment) dispersion, and for example, a general dispersion unit such as a rotary shear-type homogenizer, a ball mill, a sand mill, a dynomill, and an ultimizer having a medium can be adopted, and the preparation method is not limited at all. The colorant is dispersed in water together with an ionic surfactant or a polymeric electrolyte such as a polymeric acid and a polymeric base. A volume-average particle diameter of colorant particles to be dispersed may be 20 μm or less, but for example, is desirably in a range of 3 μm or more and 16 μm or less because dispersibility of the colorant in the toner is favorable without impairing aggregating properties.

In addition, a dispersion of the lustrous metal pigment coated with the binding resin may be prepared by dispersing and dissolving and mixing the lustrous metal pigment and the binding resin in a solvent, and then dispersing the mixture in water by phase transfer emulsification or shear emulsification.

### Aggregation Step

In the aggregation step, the dispersion of the resin particles, the colorant dispersion, the release agent dispersion, and the like are mixed to form a mixed solution, and the mixed liquid is heated at a temperature equal to or lower than a glass transition temperature of the resin particles to be aggregated, thereby forming aggregated particles. The formation of the aggregated particles is usually carried out by making a pH of the mixed solution acidic under stirring. The pH is, for example, desirably in a range of 2 or more and 7 or less, and in this case, it is also effective to use an aggregating agent.

In addition, in the aggregation step, the release agent dispersion may be added and mixed at once with various dispersions such as the resin particle dispersion, or may be added in a plurality of times.

In the aggregation step, for example, by using a stirring blade that forms a laminar flow having two paddles and stirring at a high stirring speed (for example, 500 rpm or more and 1,500 rpm or less), an orientation of the major axis direction of the metal pigment is aligned in the aggregated particles, and the aggregated particles are also aggregated in the major axis direction, and thus a thickness of the toner is reduced (that is, the above-described requirement (1) is satisfied).

As the aggregating agent, a surfactant, an inorganic metal salt, or a di- or higher valent metal complex, having a polarity opposite to the surfactant used in the dispersant described above, is used. In particular, in a case where a metal complex is used, for example, the amount of the surfactant used can be reduced, and the charge characteristics are improved, that is particularly desirable.

As the above-described inorganic metal salt, particularly, for example, an aluminum salt or a polymer thereof is suitable. In order to obtain a narrower particle size distribution, for example, it is more suitable that the valence of the inorganic metal salt is divalent rather than monovalent, trivalent rather than divalent, and tetravalent rather than trivalent; and for example, a polymer of the inorganic metal salt is more suitable even in a case where the valence is the same.

In the present exemplary embodiment, for example, it is desirable to use a polymer of a tetravalent inorganic metal salt containing aluminum in order to obtain the narrow particle size distribution.

In addition, the toner having a configuration in which a surface of core aggregated particles is coated with a resin may be produced by adding the resin particle dispersion thereto in a case where the above-described aggregated particles have a desired particle diameter (coating step). In this case, since the release agent or the colorant is less likely to be exposed to the toner surface, the configuration is, for example, desirable from the viewpoint of chargeability or developability. In a case of the re-addition, the aggregating agent may be added before the re-addition, or pH adjustment may be performed.

### Fusion Step

In the fusion step, the progress of the aggregation is stopped by raising a pH of a suspension of the aggregated particles to a range of 3 or more and 9 or less under stirring conditions similar to the conditions in the above-described aggregation step, and the aggregated particles are fused by heating at a temperature equal to or higher than a glass transition temperature of the above-described resin. In addition, in a case of being coated with the above-described resin, the resin also fuses and coats the core aggregated particles. A time of the above-described heating may be long enough to fuse the materials together, and the heating may be performed for approximately 0.5 hours or more and 10 hours or less.

In the fusion step, by fusing the aggregated particles at a lower temperature (for example, 60° C. or higher and 80° C. or lower), movement associated with the re-disposition of the material is reduced, the aligning properties of the pigment are maintained, and thus the toner particles satisfying the above-described requirement (2) are obtained.

After the fusion, the obtained mixture is cooled to obtain fused particles. In addition, in the cooling step, crystallization may be promoted by performing so-called slow cooling in which a cooling rate is lowered in the vicinity of the glass transition temperature of the resin (in a range of the glass transition temperature±10° C.).

The fused particles obtained by the fusion are subjected to a solid-liquid separation step such as filtration, and as necessary a washing step and a drying step to obtain the toner particles.

In order to adjust charge, impart fluidity, impart charge exchange properties, and the like, inorganic oxides such as silica, titania, and aluminum oxide are added and attached as an external additive to the obtained toner particles. The addition can be carried out by, for example, a V-type blender, a Henschel mixer, a Raderger mixer, or the like, and the attachment may be carried out in stages. An amount of the external additive added is, for example, in a range of 0.1 parts or more and 5 parts or less, and more preferably in a range of 0.3 parts or more and 2 parts or less with respect to 100 parts of the toner particles.

Furthermore, as necessary, the coarse particles of the toner may be removed after the external addition, using an ultrasonic sieve shaker, a vibrating sieve shaker, an air sieve shaker, or the like.

In addition to the above-described inorganic oxide and the like, other components (particles) such as a charge control agent, organic particles, a lubricant, and an abrasive may be added as the external additive.

The charge control agent is not particularly limited, but for example, a colorless or light-colored charge control agent is desirably used. Examples thereof include a quaternary ammonium salt compound, a nigrosin-based compound, a complex of aluminum, iron, chromium, or the like, and a triphenylmethane-based pigment.

Examples of the organic particles include particles generally used as an external additive on the surface of the toner, such as a vinyl-based resin, a polyester resin, and a silicone resin. These inorganic particles or organic particles are used as a fluidity assistant, a cleaning assistant, or the like.

Examples of the lubricant include fatty acid amides such as ethylenebisstearamide and oleic acid amide, and fatty acid metal salts such as zinc stearate and calcium stearate.

Examples of the abrasive include silica, alumina, cerium oxide, and the like described above.

Next, a method of manufacturing the toner particles by a dissolution suspension method will be described in detail.

In the dissolution suspension method, a material containing the binding resin, the colorant, and other components used as necessary, such as a release agent, is dissolved or dispersed in a solvent capable of dissolving the binding resin. Next, the dissolved or dispersed solution is granulated in an aqueous medium containing an inorganic dispersant, and then the above-described solvent is removed to obtain the toner particles.

Examples of other components used in the dissolution suspension method, in addition to the release agent, include various components such as an internal additive, a static control agent, an inorganic powder (inorganic particles), and organic particles.

In the present exemplary embodiment, the binding resin, the colorant, and the other components used as necessary are dissolved or dispersed in a solvent capable of dissolving the binding resin. Whether or not the binding resin can be dissolved depends on constituent components of the binding resin, a molecular chain length, a degree of three-dimensionalization, and the like, and thus cannot be indiscriminately determined. However, in general, a hydrocarbon such as toluene, xylene, and hexane; a halogenated hydrocarbon such as methylene chloride, chloroform, dichloroethane, and dichloroethylene; an alcohol or an ether such as ethanol, butanol, benzyl alcohol ethyl ether, benzyl alcohol isopropyl ether, tetrahydrofuran, and tetrahydropyrane; an ester such as methyl acetate, ethyl acetate, butyl acetate, and isopropyl acetate; a ketone or an acetal such as acetone, methyl ethyl ketone, diisobutyl ketone, dimethyl oxide, diacetone alcohol, cyclohexanone, and methyl cyclohexanone; or the like is used.

These solvents dissolve the binding resin, and it is not necessary to dissolve the colorant and the other components. The colorant and the other components may be dispersed in the solution of the binding resin. An amount of the solvent used is not limited as long as a viscosity that the granulation can be performed in the aqueous medium is obtained. A ratio of the material containing the binding resin, the colorant, and the other components and the solvent is, for example, preferably 10/90 to 50/50 (mass ratio of the former and the latter) from the viewpoint of ease of granulation and yield of the final toner particles.

A liquid (toner mother liquid) of the binding resin, the colorant, and other components, dissolved or dispersed in the solvent, is granulated to have a predetermined particle diameter in the aqueous medium containing the inorganic dispersant. As the aqueous medium, water is mainly used. A mixing ratio of the aqueous medium and the toner mother liquid is, for example, preferably aqueous medium/toner mother liquid=90/10 to 50/50 (mass ratio). As the inorganic dispersant, for example, a material selected from tricalcium phosphate, hydroxyapatite, calcium carbonate, titanium oxide, or silica powder is preferable. An amount of the inorganic dispersant used is determined according to a particle diameter of the particles to be granulated, but in general, the amount is, for example, preferably used in a range of 0.1% by mass or more and 15% by mass or less with respect to the toner mother liquid. In a case where the amount is less than 0.1% by mass, the granulation may not be performed satisfactorily; and in a case where the amount is more than 15% by mass, unnecessary fine particles may be generated, and the target particles may be obtained with difficulty at a high yield.

In order to satisfactorily granulate the toner mother liquid in the aqueous medium containing the inorganic dispersant, an auxiliary agent may be added to the aqueous medium. Examples of such an auxiliary agent include known cationic, anionic, or nonionic surfactants, and for example, anionic surfactants are particularly preferable. Examples thereof include sodium alkylbenzene sulfonate, sodium α-olefin sulfonate, and sodium alkyl sulfonate; and for example, it is preferable to use the agent in a range of 1×10⁻⁴% by mass or more and 0.1% by mass or less with respect to the toner mother liquid.

The granulation of the toner mother liquid in the aqueous medium containing the inorganic dispersant is, for example, preferably carried under shearing. The toner mother liquid dispersed in the aqueous medium is granulated, for example, preferably to have an average particle diameter of 20 μm or less. In particular, the average particle diameter is, for example, preferably 3 μm or more and 15 μm or less.

As a device including the shearing mechanism, various dispersers can be used, and among the dispersers, for example, a homogenizer is preferable. By using a homogenizer, substances (in the present exemplary embodiment, the aqueous medium containing the inorganic dispersant and the toner mother liquid) incompatible with each other can be passed through a gap between a casing and a rotating rotor, and thus the substances incompatible with the liquid can be dispersed in the liquid in a particle shape. Examples of the homogenizer include a TK homomixer, a line flow homomixer, an auto homomixer (all of which are manufactured by TOKUSYU KIKA KOGYO KK); a SILVERSON homogenizer (manufactured by SILVERSON), and a POLYTRON homogenizer (manufactured by KINEMATICA AG).

A stirring condition for using the homogenizer is, for example, preferably 2 m/sec or more in terms of circumferential speed of the blade of the rotor. In a case where the circumferential speed is less than the above-described value, the particle size is likely to be insufficient. In the present exemplary embodiment, the toner mother liquid is granulated in the aqueous medium containing the inorganic dispersant, and then the solvent is removed. The solvent may be removed at room temperature (25° C.) and normal pressure, but since it takes a long time to remove the solvent, it is preferable to remove the solvent under a temperature condition lower than a boiling point of the solvent and a range of a difference of 80° C. or lower from the boiling point. The pressure may be atmospheric pressure or reduced pressure, but in a case of reducing the pressure, for example, it is preferable to be at 20 mmHg or more and 150 mmHg or less.

In the present exemplary embodiment, it is preferable to wash the toner particles with hydrochloric acid or the like after the removal of the solvent. In this manner, the inorganic dispersant remaining on the surface of the toner particles is removed, and the original formulation of the toner particles is restored, whereby the characteristics are improved. Next, the toner particles in a form of powder can be obtained by carrying out dehydration and drying.

In the toner particles obtained by the dissolution suspension method, same as the coagulation method, in order to adjust charge, impart fluidity, impart charge exchange properties, and the like, inorganic oxides such as silica, titania, and aluminum oxide are added and attached as an external additive to the obtained toner particles. In addition to the above-described inorganic oxide and the like, other components (particles) such as a charge control agent, organic particles, a lubricant, and an abrasive may be added as the external additive.

In the present exemplary embodiment, in order to set the average value of the ratio b/a of the lustrous toner particles in the range of 0.5 or more and 0.8 or less, a method of adjusting the amount of the binding resin used for the metal pigment, the heating time during the fusion step in the coagulation method, and the like can be used. For example, by increasing the amount of the binding resin used for the metal pigment, it is easy to increase the average value of the ratio b/a of the toner particles. In addition, by increasing the heating time during the fusion step, it is easy to increase the average value of the ratio b/a of the toner particles.

In addition, for example, the ratio b/a is adjusted to a preferred range by the above-described stirring conditions in the aggregation step. More specifically, the ratio b/a can be reduced by stirring at a high speed and heating at a constant temperature in a stage of forming the aggregated particles, and the ratio b/a can be increased by stirring at a low speed and further heating.

Furthermore, for example, in order to adjust the ratio b/a to the preferred range, the toner particles may be treated with a ball mill.

In the present exemplary embodiment, in order to set the pigment area ratio in the range of 0.5 or more and 0.7 or less, a method of adjusting the average equivalent circle diameter of the metal pigment, the amount of the binding resin used for the metal pigment, the heating time during the fusion step in the coagulation method, and the like can be used. For example, the average equivalent circle diameter of the metal pigment is increased to increase the pigment area ratio. In addition, by increasing the amount of the binding resin used for the metal pigment, the pigment area ratio is easily reduced. In addition, by increasing the heating time during the fusion step, the pigment area ratio is easily increased.

### Electrostatic Image Developer

The electrostatic image developer used in the present exemplary embodiment contains at least the toner according to the present exemplary embodiment.

The electrostatic image developer used in the present exemplary embodiment may be a one-component developer that contains only the toner according to the present exemplary embodiment or a two-component developer that is obtained by mixing the toner and a carrier together.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating a core material, that are particles configuring the carrier, with a coating resin.

Examples of the magnetic powder include magnetic metals such as iron, nickel, and cobalt; and magnetic oxides such as ferrite and magnetite. In particular, for example, magnetite or ferrite is preferable. The magnetic powder may be used as particles dispersed in a resin.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene/acrylic acid ester copolymer, a straight silicone resin configured with an organosiloxane bond, a product obtained by modifying the straight silicone resin, a fluororesin, polyester, polycarbonate, a phenol resin, and an epoxy resin.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, that are used as necessary, in an appropriate solvent, and the like. The solvent is not particularly limited, and may be selected in consideration of the type of the coating resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and removing solvents.

The mixing ratio (mass ratio) between the toner and the carrier, represented by toner:carrier, in the two-component developer is, for example, preferably 1:100 to 30:100, and more preferably 3:100 to 20:100.

### Fixing Device

Examples of the fixing device according to the present exemplary embodiment include a fixing device that includes a fixing member, a rotating body disposed in contact with an outer peripheral surface of the fixing member, and a pressing member disposed inside the fixing member and pressing the fixing member toward the rotatable body from an inner peripheral surface of the fixing member. As the fixing member, the fixing member according to the present exemplary embodiment is applied.

Hereinafter, an example of the fixing device according to the present exemplary embodiment will be described with reference to the drawing.

### First Exemplary Embodiment of Fixing Device

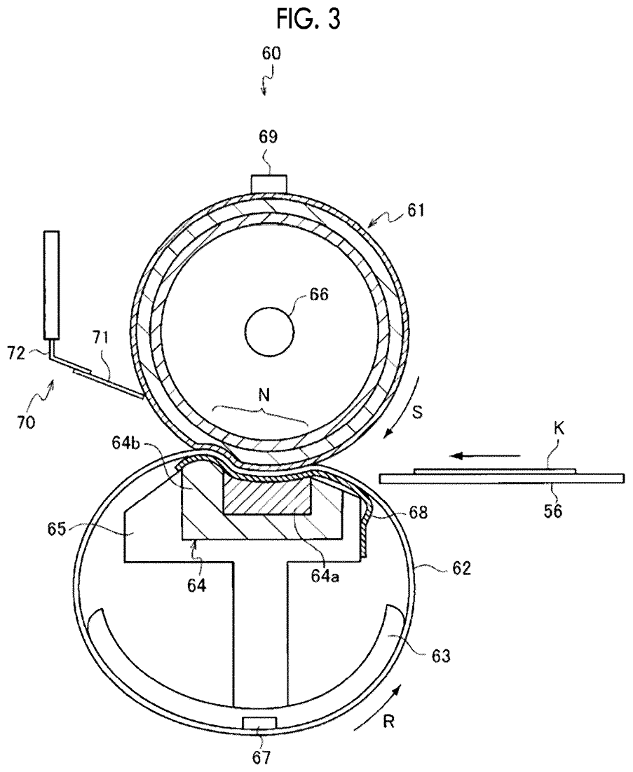

The first exemplary embodiment of the fixing device will be described with reference to FIG. 3. FIG. 3 is a schematic view showing a configuration of an example (that is, a fixing device 60) of the fixing device according to the first exemplary embodiment.

As shown in FIG. 3, the fixing device 60 is configured, for example, with a heating roll 61 (an example of the rotating body) that is driven to rotate, a pressurizing belt 62 (an example of the fixing member), and a pressing pad 64 (an example of a pressing member) that presses the heating roll 61 through the pressurizing belt 62.

Regarding the pressing pad 64, for example, the pressurizing belt 62 and the heating roll 61 may be relatively pressed. Therefore, the pressurizing belt 62 may be pressed against the heating roll 61, or the heating roll 61 may be pressed against the pressurizing belt 62.

A halogen lamp 66 (an example of a heating device) is disposed inside the heating roll 61. The heating unit is not limited to the halogen lamp, and other heating members that generate heat may be used.

Meanwhile, for example, a temperature-sensitive element 69 is disposed in contact with a surface of the heating roll 61. The lighting of the halogen lamp 66 is controlled based on a temperature measurement value by the temperature-sensitive element 69, and a surface temperature of the heating roll 61 is kept at a target set temperature (for example, 170° C.).

For example, the pressurizing belt 62 is rotatably supported by the pressing pad 64 and a belt traveling guide 63 that are disposed inside the pressurizing belt 62. In a sandwiching region N (nip portion), the pressurizing belt 62 is disposed to be pressed against the heating roll 61 by the pressing pad 64.

The pressing pad 64 is, for example, disposed in a state of being pressed against the heating roll 61 through the pressurizing belt 62 inside the pressurizing belt 62, and forms the sandwiching region N with the heating roll 61.

In the pressing pad 64, for example, a front sandwiching member 64a for securing a wide sandwiching region N is disposed on the inlet side of the sandwiching region N, and a peeling sandwiching member 64b for imparting distortion to the heating roll 61 is disposed on the outlet side of the sandwiching region N.

In order to reduce sliding resistance between an inner peripheral surface of the pressurizing belt 62 and the pressing pad 64, for example, a sheet-like sliding member 68 is provided on surfaces of the front sandwiching member 64a and the peeling sandwiching member 64b in contact with the pressurizing belt 62. The pressing pad 64 and the sliding member 68 are held by a metal holding member 65.

For example, the belt traveling guide 63 is attached to the holding member 65, and the pressurizing belt 62 is configured to rotate.

The heating roll 61 rotates, for example, in a direction of an arrow S by a drive motor (not shown), and following the above rotation, the pressurizing belt 62 rotates in a direction of an arrow R, opposite to the rotation direction of the heating roll 61. That is, for example, the heating roll 61 rotates clockwise in FIG. 3, while the pressurizing belt 62 rotates counterclockwise.

Paper K (an example of a recording medium) having an unfixed toner image is guided by, for example, a fixing inlet guide 56, and transported to the sandwiching region N. While the paper K is passing through the sandwiching region N, the unfixed toner image on the paper K is fixed by the pressure and heat acting on the sandwiching region N.

In the fixing device 60, for example, by the front sandwiching member 64a in the form of a recess conforming to an outer peripheral surface of the heating roll 61, the wide sandwiching region N is secured, compared to a configuration having no front sandwiching member 64a.

In addition, in the fixing device 60, for example, the peeling sandwiching member 64b is disposed to protrude from the outer peripheral surface of the heating roll 61 such that the distortion of the heating roll 61 is locally increased in an outlet region of the sandwiching region N.

In a case where the peeling sandwiching member 64b is disposed as described above, for example, the paper K after the fixing passes through a distortion portion formed locally large in a case of passing through the peeling sandwiching region, and thus the paper K is easy to be peeled off from the heating roll 61.

As an auxiliary unit for the peeling, for example, a peeling member 70 is disposed on the downstream side of the sandwiching region N of the heating roll 61. The peeling member 70 is, for example, held by a holding member 72 in a state in which a peeling claw 71 is close to the heating roll 61 in a direction facing the rotation direction of the heating roll 61 (counter direction).

### Second Exemplary Embodiment of Fixing Device

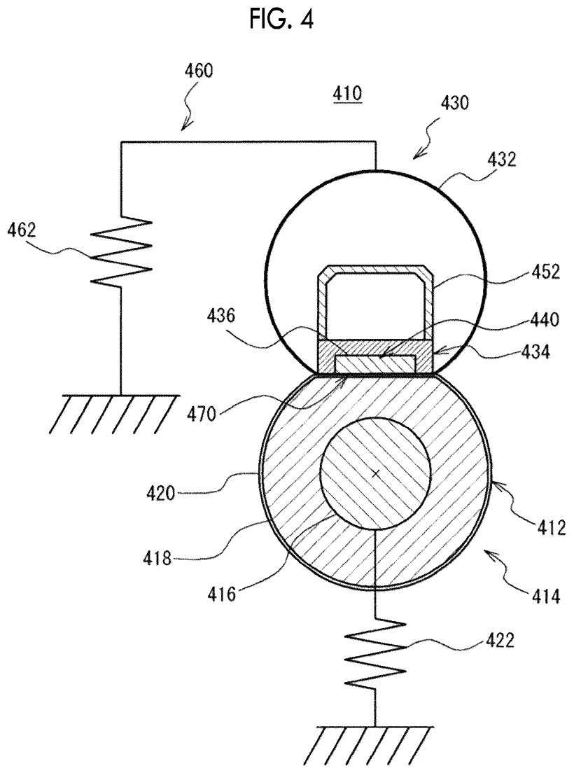

The second exemplary embodiment of the fixing device will be described with reference to FIG. 4. FIG. 4 is a schematic view showing a configuration of an example (that is, a fixing device 410) of the fixing device according to the second exemplary embodiment.

As shown in FIG. 4, the fixing device 410 has a pressure portion 414 and a heating portion 430 facing the pressure portion 414.

The pressure portion 414 includes a cylindrical roll member 412 (an example of the rotating body), is provided to face the heating portion 430, and is pressed against an outer surface of a heating belt 432 of the heating portion 430 and rotates by a drive device (not shown).

In the pressure portion 414, the roll member 412 is a so-called soft roll having a shaft portion 416 that consists of, for example, a metal material such as iron, stainless steel, and aluminum, an elastic layer 418 that covers the shaft portion 416, and a release layer 420 that coats or is applied to the elastic layer 418. The release layer 420 is formed of an insulating material having excellent release properties, such as PFA.

In the pressure portion 414, the roll member 412 is grounded, and the pressure portion 414 is grounded from the shaft portion 416 of the roll member 412 with a pressurizing portion-side resistor 422 interposed therebetween. By grounding the pressure portion 414 through the pressurizing portion-side resistor 422 in this way, the current leakage (leakage current) from the electrode of a planar heating element 440 of the heating portion 430 is suppressed.

In the pressure portion 414, the roll member 412 is pressed on the heating portion 430 by a pressing member (not shown) made of an elastic substance such as a coil spring. For example, one end of the pressing member is mounted on the shaft portion 416, and the other end is mounted on a body of an image forming apparatus.

The heating portion 430 has the heating belt 432 (an example of the fixing member) and has, on the inside of the heating belt 432, the planar heating element 440 that is a heating member heating the heating belt 432 from the inner peripheral surface side, a holding member 434 that holds the planar heating element 440, and a frame member 452 that supports the holding member 434. The holding member 434 is supported by the frame member 452, and has a structure that can withstand the pressure from the pressure portion 414.

A unit consisting of the planar heating element 440, the holding member 434, and the frame member 452 corresponds to an example of the pressing member.

In the heating portion 430, for example, a circular support member (not shown) that supports the heating belt 432 is provided on both ends of the heating belt 432 in the longitudinal direction. The support member is provided with a heating member gear (not shown) that rotates the heating belt 432. One side of the heating member gear is connected to a driving device (not shown), such as a motor in the body of the image forming apparatus. The heating belt 432 is rotated.

In the heating portion 430, the planar heating element 440 as the heating member is, for example, in the form of a long plate-shaped element extending in the longitudinal direction of the heating portion 430. The planar heating element 440 has an electrically insulating substrate, an insulating layer formed of a polyimide-based heat-resistant resin, a pair of electrodes for power supply, and a resistive heating portion made, for example, of stainless steel that generates heat by being supplied with power from the electrodes. The electrodes and the resistive heating portion are connected by a power supply portion, and the electrodes, the power supply portion, and the resistive heating portion are embedded in an insulating layer. The electrodes of the planar heating element 440 are grounded with the heating portion-side resistor 462 interposed therebetween.

In the heating portion 430, the holding member 434 is formed of, for example, a resin material such as liquid crystal polymer (LCP) having high heat resistance, and on a side of the heating portion 430 facing the pressure portion 414, a groove portion 436 for holding the planar heating element 440 is formed along the longitudinal direction.

The holding member 434 is configured to form a pressing region 470 in a case where the holding member 434 is pressed on the pressure portion 414 in a state in which the planar heating element 440 is held in the groove portion 436.

In the heating portion 430, the frame member 452 is formed of, for example, a metal material, and the frame member 452 is configured to support the holding member 434, to be fixed to a support member (not shown) through both ends of the frame member 452, and enable the holding member 434 to withstand the pressure from the pressure portion 414. The heating portion 430 may be provided with a thermistor or the like for temperature detection.

In the fixing device 410 described above, in a state in which the heating belt 432 is sandwiched between the roll member 412 of the pressure portion 414 and the unit consisting of the planar heating element 440, the holding member 434, and the frame member 452 of the heating portion 430, the pressing region 470 is formed, and a recording medium holding an unfixed toner image is passed through the pressing region 470 such that the unfixed toner image is fixed by the application of heat and pressure.

### Image Forming Apparatus

Next, the image forming apparatus according to the present exemplary embodiment will be described.

The image forming apparatus according to the present exemplary embodiment includes an image holder, a charging device that charges a surface of the image holder, a latent image forming device that forms a latent image on the charged surface of the image holder, a developing device that develops the latent image by a toner to form a toner image, a transfer device that transfers the toner image to a recording medium, and a fixing device that fixes the toner image to the recording medium.

As the fixing device, the fixing device according to the present exemplary embodiment is applied.

In the image forming apparatus according to the present exemplary embodiment, the fixing device may be made into a cartridge such that the fixing device is detachable from an image forming apparatus. That is, the image forming apparatus according to the present exemplary embodiment may include the fixing device according to the present exemplary embodiment, as a device configuring a process cartridge.

Hereinafter, the image forming apparatus according to the present exemplary embodiment will be described with reference to a drawing.

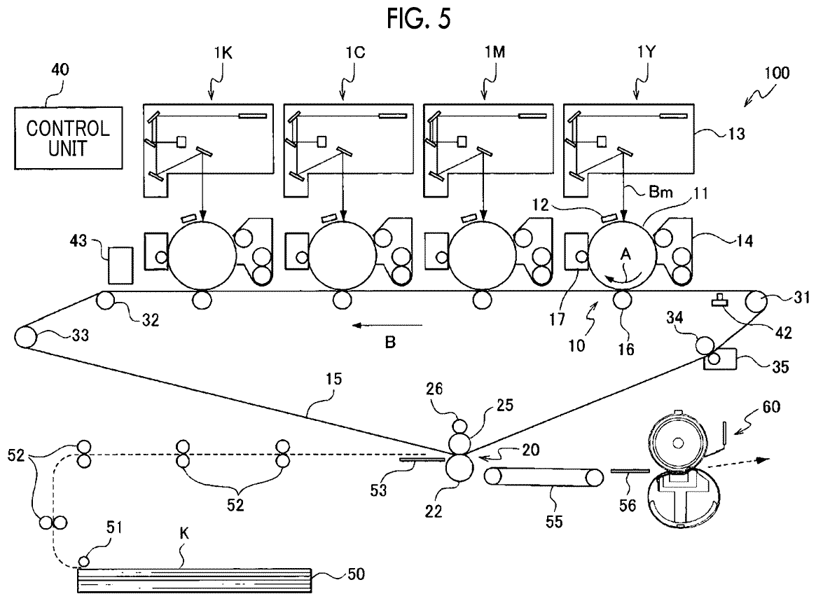

FIG. 5 is a view schematically showing a configuration of an example of the image forming apparatus according to the present exemplary embodiment.

As shown in FIG. 5, an image forming apparatus 100 according to the present exemplary embodiment is, for example, an intermediate transfer-type image forming apparatus that is generally called a tandem type, and includes a plurality of image forming units 1Y, 1M, 1C, and 1K in which a toner image of each color component is formed by an electrophotographic method, a primary transfer unit 10 that performs sequential transfer (primary transfer) of the toner image of each color component formed by each of the image forming units 1Y, 1M, 1C, and 1K to an intermediate transfer belt 15, a secondary transfer unit 20 that performs batch transfer (secondary transfer) of the overlapped toner images transferred to the intermediate transfer belt 15 to paper K as a recording medium, and a fixing device 60 that fixes the images transferred by the secondary transfer on the paper K. In addition, the image forming apparatus 100 includes a control unit 40 that controls the operation of each device (each unit).

The fixing device 60 is the first exemplary embodiment of the fixing device described above. The image forming apparatus 100 may be configured to include the second exemplary embodiment of the fixing device described above.

Each of the image forming units 1Y, 1M, 1C, and 1K of the image forming apparatus 100 includes a photoreceptor 11 that rotates in a direction of an arrow A, as an example of an image holder that holds a toner image formed on the surface.

As an example of the charging unit, a charger 12 for charging the photoreceptor 11 is provided around the photoreceptor 11, and as an example of the latent image forming unit, a laser exposure device 13 that draws an electrostatic latent image on the photoreceptor 11 is provided (in the figure, an exposure beam is represented by a reference numeral Bm).

Around the photoreceptor 11, as an example of a developing unit, there are provided a developer 14 that accommodates toners of each color component and makes the electrostatic latent image on the photoreceptor 11 into a visible image by using the toners and a primary transfer roll 16 that transfers toner images of each color component formed on the photoreceptor 11 to the intermediate transfer belt 15 by the primary transfer unit 10.

Furthermore, around the photoreceptor 11, there are provided a photoreceptor cleaner 17 that removes the residual toner on the photoreceptor 11 and devices for electrophotography, such as the charger 12, the laser exposure device 13, the developer 14, the primary transfer roll 16, and the photoreceptor cleaner 17, that are arranged in sequence along the rotation direction of the photoreceptor 11. These image forming units 1Y, 1M, 1C, and 1K are substantially linearly arranged in order of yellow (Y), magenta (M), cyan (C), and black (K) from the upstream side of the intermediate transfer belt 15.

The intermediate transfer belt 15 that is an intermediate transfer body is configured with a film-shaped pressurizing belt including a base layer that is a resin such as polyimide and polyamide, and containing an appropriate amount of an antistatic agent such as carbon black. The intermediate transfer belt 15 is configured to have a volume resistivity of 10⁶ Ω·cm or more and 10¹⁴ Ω·cm or less, and has a thickness of, for example, approximately 0.1 mm.

By various rolls, the intermediate transfer belt 15 is driven to circulate (rotate) in the B direction shown in FIG. 5 at a speed fit for the purpose. The image forming apparatus 100 has, as the various rolls, a drive roll 31 that is driven by a motor (not shown) excellent in maintaining a constant speed and rotates the intermediate transfer belt 15, a support roll 32 that supports the intermediate transfer belt 15 substantially linearly extending along the arrangement direction of each photoreceptor 11, a tension applying roll 33 that applies tension to the intermediate transfer belt 15 and functions as a correcting roll preventing meandering of the intermediate transfer belt 15, a back roll 25 that is provided in the secondary transfer unit 20, and a cleaning back roll 34 that is provided in a cleaning portion scrapping off the residual toner on the intermediate transfer belt 15.

The primary transfer unit 10 is configured with the primary transfer roll 16 that is disposed to face the photoreceptor 11 across the intermediate transfer belt 15. The primary transfer roll 16 is configured with a core and a sponge layer as an elastic layer, fixed around the core. The core is a cylindrical rod constituted of a metal such as iron and SUS. The sponge layer is a sponge-like cylindrical roll that is formed of blended rubber of NBR, SBR, and EPDM mixed with a conductive material such as carbon black, and has a volume resistivity of 10^{7.5} Ω·cm or more and 10^{8.5} Ω·cm or less.

The primary transfer roll 16 is disposed to be pressed against the photoreceptor 11 with the intermediate transfer belt 15 therebetween, and a voltage with a polarity (primary transfer bias) opposite to the charging polarity (negative polarity; the same applies hereafter) of the toner is applied to the primary transfer roll 16. As a result, the toner image on each photoreceptor 11 is sequentially electrostatically sucked onto the intermediate transfer belt 15, which leads to the formation of overlapped toner images on the intermediate transfer belt 15.

The secondary transfer unit 20 is configured to include the back roll 25 and a secondary transfer roll 22 that is disposed on a toner image-holding surface side of the intermediate transfer belt 15.

A surface of the back roll 25 is configured with a tube of blended rubber of EPDM and NBR in which carbon is dispersed, and the inside of the back roll 25 is configured with EPDM rubber. The back roll 25 is formed such that a surface resistivity thereof is 10⁷ Ω/□ or more and 10¹⁰Ω/□ or less, and a hardness of the back roll 25 is set to, for example, 70° (ASKER C: manufactured by KOBUNSHI KEIKI CO., LTD.; the same applies hereinafter). The back roll 25 is disposed on the back surface side of the intermediate transfer belt 15 to configure a counter electrode of the secondary transfer roll 22, and a power supply roll 26 made of a metal to which secondary transfer bias is stably applied is disposed to come into contact with the back roll 25.

The secondary transfer roll 22 is configured with a core and a sponge layer as an elastic layer, fixed around the core. The core is a cylindrical rod constituted of a metal such as iron and SUS. The sponge layer is a sponge-like cylindrical roll that is formed of blended rubber of NBR, SBR, and EPDM mixed with a conductive material such as carbon black, and has a volume resistivity of 10^{7.5} Ω·cm or more and 10^{8.5} Ω·cm or less.

The secondary transfer roll 22 is disposed to be pressed on the back roll 25 across the intermediate transfer belt 15, and the secondary transfer roll 22 is grounded such that the secondary transfer bias is formed between the secondary transfer roll 22 and the back roll 25, that induces secondary transfer of the toner image onto the paper K transported to the secondary transfer unit 20.

On the downstream side of the secondary transfer unit 20 of the intermediate transfer belt 15, an intermediate transfer belt cleaner 35 that removes the residual toner or paper powder on the intermediate transfer belt 15 remaining after the secondary transfer and cleans the surface of the intermediate transfer belt 15 is provided to be separable from the intermediate transfer belt 15.

The intermediate transfer belt 15, the primary transfer unit 10 (primary transfer roll 16), and the secondary transfer unit 20 (secondary transfer roll 22) correspond to an example of the transfer unit.

On the other hand, on the upstream side of the yellow image forming unit 1Y, a reference sensor (home position sensor) 42 is disposed that generates a reference signal to be a reference for taking the image forming timing in each of the image forming units 1Y, 1M, 1C, and 1K. The reference sensor 42 recognizes a mark provided on the back side of the intermediate transfer belt 15 and generates a reference signal, and each of the image forming units 1Y, 1M, 1C, and 1K is configured such that these units start to form images according to the instruction from the control unit 40 based on the recognition of the reference signal.

In addition, an image density sensor 43 used to adjust image quality is provided on the downstream side of the black image forming unit 1K.

The image forming apparatus according to the present exemplary embodiment includes, as a transport unit for transporting the paper K, a paper storage portion 50 that stores the paper K, a paper feeding roll 51 that takes out and transports the paper K stacked in the paper storage portion 50 at a predetermined timing, a transport roll 52 that transports the paper K transported by the paper feeding roll 51, a transport guide 53 that sends the paper K transported by the transport roll 52 to the secondary transfer unit 20, a transport belt 55 that transports the paper K transported after going through secondary transfer by the secondary transfer roll 22 to the fixing device 60, and a fixing inlet guide 56 that guides the paper K to the fixing device 60.

Next, basic image forming process of the image forming apparatus according to the present exemplary embodiment will be described.

In the image forming apparatus according to the present exemplary embodiment, image data output from an image reading device (not shown), a personal computer (PC) (not shown), or the like is subjected to image processing by an image processing device (not shown), and then the image forming units 1Y, 1M, 1C, and 1K perform the image forming operation.

In the image processing device, various types of image processing, such as shading correction, misregistration correction, brightness/color space conversion, gamma correction, frame removal or color editing, and movement editing, are performed on input image data. Image data on which the image processing is performed are converted into color material gradation data of four colors, that is, Y, M, C, and K, and are output to the laser exposure device 13.

In the laser exposure device 13, according to the input color material gradation data, for example, the photoreceptor 11 of each of the image forming units 1Y, 1M, 1C, and 1K is irradiated with an exposure beam Bm emitted from a semiconductor laser. The surface of each of the photoreceptors 11 of the image forming units 1Y, 1M, 1C, and 1K is charged by the charger 12, and is then scanned and exposed by the laser exposure device 13, so that the electrostatic latent image is formed. By each of the image forming units 1Y, 1M, 1C, and 1K, the formed electrostatic latent image is developed as a toner image of each of the colors Y, M, C, and K.

The toner image formed on each of the photoreceptors 11 of the image forming units 1Y, 1M, 1C, and 1K is transferred onto the intermediate transfer belt 15 at the primary transfer unit 10 where each photoreceptor 11 and the intermediate transfer belt 15 are in contact with each other. More specifically, in the primary transfer unit 10, by the primary transfer roll 16, a voltage (primary transfer bias) with a polarity opposite to the charging polarity (negative polarity) of the toner is applied to the base material of the intermediate transfer belt 15, and the toner images are sequentially overlapped on the surface of the intermediate transfer belt 15 and subjected to primary transfer.

After the primary transfer by which the toner images are sequentially transferred to the surface of the intermediate transfer belt 15, the intermediate transfer belt 15 moves, and the toner images are transported to the secondary transfer unit 20. In a case where the toner images are transported to the secondary transfer unit 20, in the transport unit, the paper feeding roll 51 rotates in accordance with the timing at which the toner images are transported to the secondary transfer unit 20, and the paper K having the target size is fed from the paper storage portion 50. The paper K fed from the paper feeding roll 51 is transported by the transport roll 52, passes through the transport guide 53, and reaches the secondary transfer unit 20. Before reaching the secondary transfer unit 20, the paper K is temporarily stopped, and a positioning roll (not shown) rotates according to the movement timing of the intermediate transfer belt 15 holding the toner image, so that the position of the paper K is aligned with the position of the toner image.

In the secondary transfer unit 20, through the intermediate transfer belt 15, the secondary transfer roll 22 is pressed on the back roll 25. At this time, the paper K transported at the right timing is interposed between the intermediate transfer belt 15 and the secondary transfer roll 22. At this time, in a case where a voltage (secondary transfer bias) with the same polarity as the charging polarity (negative polarity) of the toner is applied from the power supply roll 26, a transfer electric field is formed between the secondary transfer roll 22 and the back roll 25. In the secondary transfer unit 20 pressed by the secondary transfer roll 22 and the back roll 25, the unfixed toner images held on the intermediate transfer belt 15 are electrostatically transferred onto the paper K in a batch.

Thereafter, the paper K to which the toner images are electrostatically transferred is transported in a state of being peeled off from the intermediate transfer belt 15 by the secondary transfer roll 22, and is transported to the transport belt 55 provided on the downstream side of the secondary transfer roll 22 in the paper transport direction. The transport belt 55 transports the paper K to the fixing device 60 according to the optimum transport speed in the fixing device 60. The unfixed toner images on the paper K transported to the fixing device 60 are fixed on the paper K by being subjected to a fixing treatment by heat and pressure by the fixing device 60. The paper K on which the fixed image is formed is transported to an ejected paper-storing portion (not shown) provided in a discharge portion of the image forming apparatus.

Meanwhile, after the transfer to the paper K is finished, the residual toner remaining on the intermediate transfer belt 15 is transported to the cleaning portion as the intermediate transfer belt 15 rotates, and is removed from the intermediate transfer belt 15 by the cleaning back roll 34 and the intermediate transfer belt cleaner 35.

Although the present exemplary embodiment has been described, the present exemplary embodiment is not limited to the above-described exemplary embodiments, and various modifications, changes, and ameliorations may be added thereto.

### EXAMPLES

Hereinafter, the present exemplary embodiment will be described in more detail by Examples, but the present exemplary embodiment is not limited to Examples. In the following description, unless otherwise specified, “part” and “%” are based on mass.

### Example 1

### Production of Developer

### Preparation of Metal Pigment Dispersion

Aluminum pigment (manufactured by Showa Aluminum Powder Ltd., 2173EA): 100 parts
Anionic surfactant (manufactured by DKS Co. Ltd., NEOGEN R): 1.5 parts
Deionized water: 400 parts

A solvent is removed from a paste of the aluminum pigment, and the pigment is mechanically pulverized and classified using a starmill (manufactured by Ashizawa Finetech Ltd., LMZ). Thereafter, the above-described active agent and deionized water are mixed therewith, and dispersed for approximately 1 hour using an emulsification disperser CAVITRON (manufactured by Taihei Kogyo Co., Ltd., CR1010) to prepare a metal pigment dispersion in which metal pigment particles (aluminum pigment) are dispersed (concentration of solid contents: 20%). An average equivalent circle diameter of the dispersion is 15 μm.

### Synthesis of Amorphous Polyester Resin

Ethylene oxide (2.2 mol) adduct of bisphenol A: 40 mol %
Propylene oxide (2.2 mol) adduct of bisphenol A: 60 mol %
Terephthalic acid: 47 mol %
Fumaric acid: 40 mol %
Dodecenyl succinic acid anhydride: 15 mol %
Trimellitic acid anhydride: 3 mol %

A reaction container equipped with a stirrer, a thermometer, a condenser, and a nitrogen gas introduction pipe is charged with 0.25 parts of dioctanoyltin, other than fumaric acid and trimellitic acid anhydride among the above-described monomer components, with respect to the total of 100 parts of the above-described monomer components. The mixture is allowed to react at 235° C. for 6 hours in a nitrogen gas stream and cooled to 200° C., the fumaric acid and the trimellitic acid anhydride described above are added to the mixture, and the mixture is allowed to react for 1 hour. The temperature is raised to 220° C. over 4 hours, the mixture is polymerized under a pressure of 10 kPa until a target molecular weight is obtained to obtain a pale yellow transparent amorphous polyester resin.

As the measurement results for the obtained amorphous polyester resin, a glass transition temperature Tg measured by DSC is 59° C., a mass-average molecular weight Mw measured by GPC is 25,000, a number-average molecular weight Mn is 7,000, a softening temperature measured by a flow tester is 107° C., and an acid value AV is 13 mgKOH/g.

### Preparation of Amorphous Polyester Resin Dispersion

In a state in which a 3 L reaction vessel equipped with a jacket (BJ-30N, manufactured by Tokyo Rikakikai Co., Ltd.) including a condenser, a thermometer, a water dripping device, and an anchor blade is maintained at 40° C. in a water circulation type constant temperature vessel, a mixed solution of 160 parts of ethyl acetate and 100 parts of isopropyl alcohol is put into the reaction vessel, 300 parts of the above-described amorphous polyester resin is put into the reaction vessel, and the solution is stirred at 150 rpm using a three-one motor for dissolution, thereby obtaining an oil phase. 14 parts of a 10% ammonia aqueous solution is added dropwise to the oil phase while being stirred for a dripping time of 5 minutes and mixed for 10 minutes, and 900 parts of deionized water is further added thereto at a rate of 7 parts/min to invert the phase, thereby obtaining an emulsified liquid.

Immediately, 800 parts of the obtained emulsified liquid and 700 parts of deionized water are put in a 2 L eggplant flask and set in an evaporator (Tokyo Rikakikai Co., Ltd.) equipped with a vacuum controlled unit through a trap ball. While being rotated, the eggplant flask is heated in a hot water bath at 60° C., and the pressure is reduced to 7 kPa with care to sudden boiling, thereby removing the solvent. At a point in time when the amount of solvent collected reaches 1,100 parts, the pressure is returned to normal pressure, and the eggplant flask is cooled in water, thereby obtaining a dispersion. The obtained dispersion has no solvent odor. A volume-average particle size D50v of the resin particles in the dispersion is 130 nm. In the following, as the volume-average particle size D50v, an average value of three measured values excluding the maximum value and the minimum value among five measurements using a microtrac is used.

Thereafter, deionized water is added thereto to adjust the concentration of solid contents to 20%, and the resultant is used as an amorphous polyester resin dispersion.

### Synthesis of Crystalline Polyester Resin

1,10-Dodecanedioic acid: 50 mol %
1,9-Nonanediol: 50 mol %

The above-described monomer components are charged into a reaction container equipped with a stirrer, a thermometer, a condenser, and a nitrogen gas introduction tube, the inside of the reaction container is replaced with dry nitrogen gas, and 0.25 parts of titanium tetrabutoxide (reagent) is added to 100 parts of the above-described monomer components. The mixture is stirred and allowed to react at 170° C. for 3 hours in a nitrogen gas stream and further heated to a temperature of 210° C. for 1 hour, the pressure the inside of the reaction container is reduced to 3 kPa, and the mixture is stirred and allowed to react under reduced pressure for 13 hours, thereby obtaining a crystalline polyester resin.

As the measurement results of the obtained crystalline polyester resin, a melting temperature measured by DSC is 73.6° C., a mass-average molecular weight Mw measured by GPC is 25,000, a number-average molecular weight Mn is 10,500, and an acid value AV is 10.1 mgKOH/g.

### Preparation of Crystalline Polyester Resin Particle Dispersion

300 parts of the above-described crystalline polyester resin, 160 parts of methyl ethyl ketone (solvent), and 100 parts of isopropyl alcohol (solvent) are put into a 3 L reaction vessel equipped with a jacket (BJ-30N, manufactured by Tokyo Rikakikai Co., Ltd.) including a condenser, a thermometer, a water dripping device, and an anchor blade, and the resin is dissolved by stirring and mixing at 100 rpm while maintaining the temperature at 70° C. in a water circulation type constant temperature vessel (dissolved solution preparation step).

Thereafter, the stirring rotation speed is set to 150 rpm, the temperature of the water circulation type constant temperature vessel is set to 66° C., 17 parts of 10% ammonia water (reagent) is added thereto over 10 minutes, and a total of 900 parts of deionized water that has been warmed to 66° C. is added dropwise to the solution at a rate of 7 parts/min for phase inversion, thereby obtaining an emulsified liquid.

Immediately, 800 parts of the obtained emulsified liquid and 700 parts of deionized water are put in a 2 L eggplant flask and set in an evaporator (Tokyo Rikakikai Co., Ltd.) equipped with a vacuum controlled unit through a trap ball. While being rotated, the eggplant flask is heated in a hot water bath at 60° C., and the pressure is reduced to 7 kPa with care to sudden boiling, thereby removing the solvent. At a point in time when the amount of solvent collected reaches 1,100 parts, the pressure is returned to normal pressure, and the eggplant flask is cooled in water, thereby obtaining a dispersion. The obtained dispersion has no solvent odor. A volume-average particle size D50v of the resin particles in the dispersion is 130 nm. Thereafter, deionized water is added thereto to adjust the concentration of solid contents to 20%, and the resultant is used as a crystalline polyester resin dispersion.

### Production of Toner

Amorphous polyester resin dispersion: 263 parts
Crystalline polyester resin dispersion: 12 parts
Metal pigment dispersion: 100 parts
Nonionic surfactant (IGEPAL CA897): 2.5 parts

The above-described raw materials are put into a 2 L cylindrical stainless steel container, and dispersed and mixed together for 10 minutes in a state where a shearing force is applied at 4,000 rpm by a homogenizer (ULTRA-TURRAX T50 manufactured by IKA). Next, 60 parts of a 10% nitric acid aqueous solution of polyaluminum chloride as an aggregating agent is slowly added dropwise to the mixture, and dispersed and mixed for 15 minutes by the homogenizer at a rotation speed of 5,000 rpm, thereby obtaining a raw material dispersion.

Thereafter, the raw material dispersion is moved to a polymerization tank equipped with a stirrer using two paddles as stirring blades and a thermometer, and start to be heated with a mantle heater at a rotation speed for stirring of 857 rpm, and then the growth of aggregated particles is promoted at 54° C. In this case, by using an aqueous solution of 0.3 N nitric acid or 1 N sodium hydroxide, the pH of the raw material dispersion is controlled in a range of 2.2 to 3.5. The raw material dispersion is retained in the above-described pH range for approximately 2 hours so that aggregated particles are formed.

Next, 125 parts of the amorphous polyester resin dispersion is further added thereto, and the resin particles of the binding resin are attached to the surface of the aggregated particles.

Thereafter, the temperature is raised to 56° C., and the aggregated particles are arranged while confirming the size and the shape of the particles with an optical microscope and MULTISIZER II. Thereafter, 4.25 parts of a chelating agent (HIDS, manufactured by NIPPON SHOKUBAI CO., LTD.) is added thereto, the pH is adjusted to 7.8 using a 5% sodium hydroxide aqueous solution, and the mixture is allowed to stand for 15 minutes. Thereafter, the pH is raised to 8.0 so that the aggregated particles are fused, and then the dispersion is heated up to 66.5° C. After confirming with an optical microscope that the aggregated particles are fused with each other, the pH is lowered to 6.0 while maintaining the temperature at 66.5° C., the heating is stopped after 1 hour, and the solution is cooled at a cooling rate of 1.0° C./min. Subsequently, the particles are sieved with a 20 m mesh, repeatedly washed with water, and then dried in a vacuum dryer, thereby obtaining toner particles. For the obtained toner particles, a volume-average particle diameter is 17.2 μm, an average value of the ratio b/a is 0.5, and a pigment area ratio is 0.7.

1.5 parts of silica particles (RY50 manufactured by Nippon Aerosil Co., Ltd.) are mixed with 100 parts of the toner particles at a circumferential speed of 30 μm/see for 3 minutes using a Henschel mixer (manufactured by MITSUI MIIKE MACHINERY). Thereafter, the mixture is sieved using a vibration sieve having an opening of 45 μm, thereby producing a toner.

### Production of Carrier

Ferrite particles (volume-average particle diameter: 35 μm): 100 parts
Toluene: 14 parts
Perfluoroacrylate copolymer (critical surface tension: 24 dyn/cm): 1.6 parts
Carbon black (product name: VXC-72, manufactured by Cabot Corporation., volume resistivity: 100 Ωcm or less): 0.12 parts
Crosslinked melamine resin particles (average particle diameter: 0.3 μm, insoluble in toluene): 0.3 parts

First, the carbon black is diluted with toluene and added to the perfluoroacrylate copolymer, and the mixture is dispersed with a sand mill. Next, the above-described respective components other than the ferrite particles are dispersed in the mixture with a stirrer for 10 minutes to prepare a solution for forming a coating layer. Next, the solution for forming a coating layer and the ferrite particles are placed in a vacuum degassing kneader, stirred at a temperature of 60° C. for 30 minutes, and then distilled off under reduced pressure to form a resin coating layer, thereby obtaining a carrier.

### Production of Developer

36 parts of the above-described toner and 414 parts of the above-described carrier are placed in a 2 liter V-blender, stirred for 20 minutes, and then sieved through 212 μm to produce a developer.

### Toner Physical Properties

The average equivalent circle diameter of the metal pigment contained in the toner particles, the average value of the ratios b/a between the major axis diameter a and the minor axis diameter b in the cross section of the toner particles, and the average value of the areas of the metal pigment occupying the projected image of the toner particles in a case of being viewed in the thickness direction are measured. The results are shown in Table 1.

### Production of Fixing Belt

### Preparation of Amorphous Polyester Resin Dispersion

SQ1: organopolysiloxane having a silsesquioxane structure (T type; manufactured by KONISHI CHEMICAL IND CO., LTD., “SR-13H”, organopolysiloxane having only the T unit represented by the formula: [R¹SiO_{3/2}]ₘ (in the formula, R¹=methyl group)): 50%
Dimethyl organopolysiloxane (D type) (manufactured by Shin-Etsu Chemical Co., Ltd., X34-1053-A/B, adjusted to elastic modulus shown in Table 1 by adjusting ratio of A agent and B agent): 50%

The above-described components are mixed with 10% by mass of the total amount of a coating material to obtain a coating material for a surface layer.

As an elastic layer, X34-3160-A/B manufactured by Shin-Etsu Chemical Co., Ltd. is formed on a base material made of φ168 polyimide so that an average film thickness is 400 μm. Next, as a surface layer, the above-described coating material for a surface layer is formed on the elastic layer with an average film thickness of 30 μm, thereby obtaining a fixing belt.

### Examples 2 to 5 and Comparative Examples 1 and 2

A fixing belt is obtained in the same manner as in Example 1, except that the amounts of the SQ1: organopolysiloxane (T type) having a silsesquioxane structure and the dimethyl organopolysiloxane (D type) used in the surface layer of the fixing belt in Example 1 are changed to the amounts shown in Table 1.

The developer prepared in Example 1 is used as a developer.

### Example 6

A fixing belt is obtained in the same manner as in Example 1, except that, in Example 1, the SQ1: organopolysiloxane (T type) having a silsesquioxane structure used in the surface layer of the fixing belt is changed to the following SQ2.

The developer prepared in Example 1 is used as a developer.
SQ2: organopolysiloxane having a silsesquioxane structure (T type; manufactured by KONISHI CHEMICAL IND CO., LTD., “SR-23”, organopolysiloxane having only the T unit represented by the formula: [R¹SiO_{3/2}]ₘ (in the formula, R¹=phenyl group))

For the surface layer of the fixing belt obtained in each of Examples, the “difference ΔH between the maximum value and the minimum value of the ultramicrohardness” and the “tensile elongation rate” are measured. The results are shown in Table 1.

### Evaluation

The fixing belt obtained in each of Examples is mounted on a modified machine of an image forming apparatus DocuColor-7171P (manufactured by FUJIFILM Business Innovation Corp.), and the above-described developer is mounted as a developer to obtain an image forming apparatus.

### Toner Offset

10 solid images are continuously formed using the above-described image forming apparatus, and occurrence of toner stains on both sides of the paper is observed. The toner stains are evaluated according to the following standard.

### Evaluation Index

A: no toner offset-based stains are confirmed.
B: no toner offset-based stains are confirmed by visual observation, but are confirmed by observation with a magnifying glass.
C: toner offset-based stains are confirmed by visual observation.

### Luster and Luster Maintenance Property

1000 solid images are continuously formed using the above-described image forming apparatus. For the first solid image and the 100th solid image, luster is visually evaluated under color observation lighting (natural daylight lighting) according to JIS K 5600-4-3: 1999 “General Test Method for Paints—Part 4: Visual Characteristics of Coating Films—Section 3: Visual Comparison of Colors”. The evaluation is determined by 10 test subjects, and the evaluation standard is as follows.

Evaluation index (Luster)
A: 8 or more and 10 or less test subjects determine that there is luster.
B: 5 or more and 7 or less test subjects determine that there is luster.
C: 6 or more and 7 or less test subjects determine that there is no luster.
D: 8 or more and 10 or less test subjects determine that there is no luster.

In addition, the above-described luster is evaluated for the first solid image and the 1000th solid image, and the luster maintenance property is evaluated according to the following standard based on the difference in luster between the first solid image and the 1000th solid image.

Evaluation index (Luster Maintenance Property)
A: no difference in luster
B: difference in luster in a part (region of 5% or more and less than 50%) of solid image
C: difference in luster in a half of solid image (region of 50% or more and less than
90%)
D: difference in luster in entire surface (region of 90% or more) of solid image

TABLE 1

| | Lustrous toner particles | | | | | | |
|---|---|---|---|---|---|---|---|
| | Average | | | | | | |
| | equivalent | | Average | | | | |
| | circle | Average | value of | | | | |
| | diameter of | value of | pigment | Surface layer | | | |
| | pigment | ratios | area | T type | T type | D type | Difference |
| | (μm) | (b/a) | ratios | material | ratio | ratio | ΔH |
| Example 1 | 10 | 0.7 | 0.6 | SQ1 | 50% | 50% | 5 |
| Example 3 | 10 | 0.7 | 0.6 | SQ1 | 10% | 90% | 2 |
| Example 4 | 10 | 0.7 | 0.6 | SQ1 | 90% | 10% | 2 |
| Example 5 | 10 | 0.7 | 0.6 | SQ1 | 30% | 70% | 3 |
| Example 6 | 10 | 0.7 | 0.6 | SQ1 | 70% | 30% | 4 |
| Example 7 | 15 | 0.8 | 0.7 | SQ1 | 50% | 50% | 5 |
| Example 8 | 5 | 0.5 | 0.5 | SQ1 | 50% | 50% | 5 |
| Example 9 | 15 | 0.8 | 0.7 | SQ1 | 10% | 90% | 2 |
| Example 10 | 5 | 0.5 | 0.5 | SQ1 | 90% | 10% | 2 |
| Example 13 | 10 | 0.7 | 0.6 | SQ2 | 50% | 50% | 5 |
| Comparative | 10 | 0.7 | 0.6 | SQ1 | 100% | O% | 1 |
| Example 1 | | | | | | | |
| Comparative | 10 | 0.7 | 0.6 | SQ1 | O% | 100% | 1 |
| Example 2 | | | | | | | |

| | Surface layer | | | | | |
|---|---|---|---|---|---|---|
| | Tensile | B/A × | Elastic | | | Luster |
| | elongation | 100 | modulus | Toner | | maintenance |
| | rate | (%) | (Mpa) | offset | Luster | property |
| Example 1 | 200 | 38 | 45 | A | A | A |
| Example 3 | 350 | 25 | 40 | B | A | A |
| Example 4 | 160 | 44 | 50 | A | B | B |
| Example 5 | 250 | 32 | 42 | A | A | A |
| Example 6 | 180 | 39 | 47 | A | A | A |
| Example 7 | 200 | 38 | 45 | A | A | A |
| Example 8 | 200 | 38 | 45 | B | A | A |
| Example 9 | 350 | 25 | 40 | B | A | A |
| Example 10 | 160 | 44 | 50 | A | B | B |
| Example 13 | 210 | 36 | 44 | A | A | A |
| Comparative | 110 | 60 | 55 | A | D | D |
| Example 1 | | | | | | |
| Comparative | 400 | 1 | 35 | C | C | B |
| Example 2 | | | | | | |

From the results shown in Table 1, it is found that, in a case of forming an image using a toner containing lustrous toner particles, an image having high luster is obtained in Examples as compared with Comparative Examples.

Hereinafter, aspects of the present invention will be additionally described.

### <<<K>>>

An image forming apparatus comprising:
an image holder;
a charging unit that charges a surface of the image holder;
an electrostatic image forming unit that forms an electrostatic image on the charged surface of the image holder;
a developing unit that accommodates an electrostatic image developer containing a toner that contains toner particles containing a metal pigment having an average equivalent circle diameter of 5 μm or more and 15 μm or less, in which an average value of ratios b/a between a major axis diameter a and a minor axis diameter b in a cross section of the toner particles is 0.5 or more and 0.8 or less, and an average value of areas of the metal pigment occupying a projected image of the toner particles in a case of being viewed in a thickness direction is 0.5 or more and 0.7 or less, the developing unit developing the electrostatic image formed on the surface of the image holder into a toner image with the electrostatic image developer;
a transfer unit that transfers the toner image onto a recording medium; and
a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at any 50 points by an ultramicrohardness test specified in JIS Z2255 (2003), is 0 or more and 15 or less, the fixing device fixing the toner image onto the recording medium by bringing the surface layer of the fixing member into contact with the toner image on the recording medium and then heating and pressurizing the recording medium,

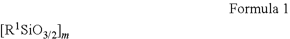

(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group,
a plurality of R¹'s may be the same or different from each other,
R² represents a hydrogen atom, a methyl group, or an ethyl group,
in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer).
   <<<2>>>

The image forming apparatus according to <<<1>>>, wherein the contained ratio (T type/D type) in the composition is 3/7 or more and 7/3 or less.

<<<3>>>

The image forming apparatus according to <<<1>>> or <<<2>>>,
wherein, in the surface layer, the difference ΔH between the maximum value and the minimum value of the ultramicrohardness is 0 or more and 5 or less.
   <<<4>>>

The image forming apparatus according to any one of <<<1>>> to <<<3>>>,
wherein the surface layer has a tensile elongation rate of 100 or more.
   <<<5>>>

The image forming apparatus according to <<<4>>>,
wherein the tensile elongation rate of the surface layer is 150 or more.
   <<<6>>>

The image forming apparatus according to any one of <<<1>>> to <<<5>>>,
wherein, in the surface layer, an average value of ratios B/A×100(%) of an indentation depth B at a time of load release to an indentation depth A at a time of load application in the ultramicrohardness test specified in JIS Z2255 (2003) is 45% or less.
   <<<7>>>

The image forming apparatus according to <<<6>>>,
wherein the average value of the ratios B/A×100(%) of the surface layer is 40% or less.
   <<<8>>>

The image forming apparatus according to any one of <<<1>>> to <<<7>>>,
wherein at least one of R¹'s is a methyl group or a phenyl group.
   <<<9>>

The image forming apparatus according to <<<8>>>,
wherein at least one of R¹'s is a methyl group.
   <<<10>>>

An image forming method comprising:
charging a surface of an image holder;
forming an electrostatic image on the charged surface of the image holder;
developing the electrostatic image formed on the surface of the image holder into a toner image with an electrostatic image developer containing a toner that contains toner particles containing a metal pigment having an average equivalent circle diameter of 5 μm or more and 15 μm or less, in which an average value of ratios b/a between a major axis diameter a and a minor axis diameter b in a cross section of the toner particles is 0.5 or more and 0.8 or less, and an average value of areas of the metal pigment occupying a projected image of the toner particles in a case of being viewed in a thickness direction is 0.5 or more and 0.7 or less;
transferring the toner image onto a recording medium; and
fixing the toner image onto the recording medium by bringing a surface layer of a fixing member into contact with the toner image on the recording medium and then heating and pressurizing the recording medium, using a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at any 50 points by an ultramicrohardness test specified in JIS Z2255 (2003), is 0 or more and 15 or less,

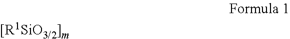

(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group,
a plurality of R¹'s may be the same or different from each other,
R² represents a hydrogen atom, a methyl group, or an ethyl group,
in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image holder;
a charging unit that charges a surface of the image holder;
an electrostatic image forming unit that forms an electrostatic image on the charged surface of the image holder;
a developing unit that accommodates an electrostatic image developer containing a toner that contains toner particles containing a metal pigment having an average equivalent circle diameter of 5 μm or more and 15 μm or less, in which an average value of ratios b/a between a major axis diameter a and a minor axis diameter b in a cross section of the toner particles is 0.5 or more and 0.8 or less, and an average value of areas of the metal pigment occupying a projected image of the toner particles in a case of being viewed in a thickness direction is 0.5 or more and 0.7 or less, the developing unit developing the electrostatic image formed on the surface of the image holder into a toner image with the electrostatic image developer;
a transfer unit that transfers the toner image onto a recording medium; and
a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at any 50 points by an ultramicrohardness test specified in JIS Z2255 (2003), is 0 or more and 15 or less, the fixing device fixing the toner image onto the recording medium by bringing the surface layer of the fixing member into contact with the toner image on the recording medium and then heating and pressurizing the recording medium, 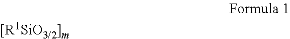
(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group,
a plurality of R¹'s may be the same or different from each other,
R² represents a hydrogen atom, a methyl group, or an ethyl group,
in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer).

2. The image forming apparatus according to claim 1,
wherein the contained ratio (T type/D type) in the composition is 3/7 or more and 7/3 or less.

3. The image forming apparatus according to claim 1,
wherein, in the surface layer, the difference ΔH between the maximum value and the minimum value of the ultramicrohardness is 0 or more and 5 or less.

4. The image forming apparatus according to claim 1,
wherein the surface layer has a tensile elongation rate of 100 or more.

5. The image forming apparatus according to claim 4,
wherein the tensile elongation rate of the surface layer is 150 or more.

6. The image forming apparatus according to claim 1,
wherein, in the surface layer, an average value of ratios B/A×100(%) of an indentation depth B at a time of load release to an indentation depth A at a time of load application in the ultramicrohardness test specified in JIS Z2255 (2003) is 45% or less.

7. The image forming apparatus according to claim 6,
wherein the average value of the ratios B/A×100(%) of the surface layer is 40% or less.

8. The image forming apparatus according to claim 1,
wherein at least one of R¹'s is a methyl group or a phenyl group.

9. The image forming apparatus according to claim 8,
wherein at least one of R¹'s is a methyl group.

10. An image forming method comprising:
charging a surface of an image holder;
forming an electrostatic image on the charged surface of the image holder;
developing the electrostatic image formed on the surface of the image holder into a toner image with an electrostatic image developer containing a toner that contains toner particles containing a metal pigment having an average equivalent circle diameter of 5 μm or more and 15 μm or less, in which an average value of ratios b/a between a major axis diameter a and a minor axis diameter b in a cross section of the toner particles is 0.5 or more and 0.8 or less, and an average value of areas of the metal pigment occupying a projected image of the toner particles in a case of being viewed in a thickness direction is 0.5 or more and 0.7 or less;
transferring the toner image onto a recording medium; and
fixing the toner image onto the recording medium by bringing a surface layer of a fixing member into contact with the toner image on the recording medium and then heating and pressurizing the recording medium, using a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at any 50 points by an ultramicrohardness test specified in JIS Z2255 (2003), is 0 or more and 15 or less, 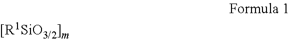
(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group,
a plurality of R¹'s may be the same or different from each other,
R² represents a hydrogen atom, a methyl group, or an ethyl group,
in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer).

11. An image forming apparatus comprising:
an image holder;
a charging means for charging a surface of the image holder;
an electrostatic image forming means for forming an electrostatic image on the charged surface of the image holder;
a developing means for accommodating an electrostatic image developer containing a toner that contains toner particles containing a metal pigment having an average equivalent circle diameter of 5 μm or more and 15 μm or less, in which an average value of ratios b/a between a major axis diameter a and a minor axis diameter b in a cross section of the toner particles is 0.5 or more and 0.8 or less, and an average value of areas of the metal pigment occupying a projected image of the toner particles in a case of being viewed in a thickness direction is 0.5 or more and 0.7 or less, the developing means for developing the electrostatic image formed on the surface of the image holder into a toner image with the electrostatic image developer;
a transfer means for transferring the toner image onto a recording medium; and
a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at any 50 points by an ultramicrohardness test specified in JIS Z2255 (2003), is 0 or more and 15 or less, the fixing device fixing the toner image onto the recording medium by bringing the surface layer of the fixing member into contact with the toner image on the recording medium and then heating and pressurizing the recording medium, 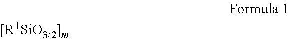
(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group,
a plurality of R¹'s may be the same or different from each other,
R² represents a hydrogen atom, a methyl group, or an ethyl group,
in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer).
